(19) United States
(12) Patent Application Publication
(10) Pub. No.: US 2026/0289093 A1
(43) Pub. Date: Sep. 24, 2026

(54) SYSTEM

(71) Applicant: SoftBank Group Corp., Tokyo (JP)

(72) Inventor: Ikki HIRABAYASHI, Tokyo (JP)

(73) Assignee: SoftBank Group Corp., Tokyo (JP)

(21) Appl. No.: 19/568,958

(22) Filed: Mar. 17, 2026

(30) Foreign Application Priority Data
Mar. 19, 2025 (JP) 2025-045213

(51) Int. Cl. G06F 40/166; G06F 40/20; G06N 20/00; H04L 51/02

(52) U.S. Cl. CPC G06F 40/166; G06F 40/20; G06N 20/00; H04L 51/02

(57) ABSTRACT

A system includes a processor that is configured to provide, to a user, an interface for inputting a genre and a setting of a creative work, analyze the input genre and setting to generate a prompt that instructs a generative artificial intelligence model to generate a story structure and character ideas, receive, from the generative artificial intelligence model, generated ideas including the story structure and the character ideas, provide the generated ideas to the user through the interface, receive feedback on the generated ideas from the user through the interface, and perform sentiment analysis on the feedback received from the user.

### CROSS-REFERENCE TO RELATED APPLICATION

This application is based on and claims priority under 35 USC 119 from Japanese Patent Application No. 2025-045213 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for assisting users in the creation of stories or other creative works typically provide static templates, simple keyword-based suggestions, or one-time outputs from generative models, without sufficiently reflecting the user's intent, preferences, or emotional reactions. As a result, the generated story structures and character ideas frequently lack alignment with the user's desired genre and setting, and also fail to adapt dynamically to the user's evolving feedback. Moreover, existing systems generally do not perform systematic sentiment analysis of user feedback, and therefore are unable to infer the user's emotional state or satisfaction level with respect to the generated ideas. Consequently, such systems cannot effectively re-evaluate or improve the quality of generated ideas in a manner that is responsive to the user's emotions and preferences. There is a need for a system that can accept user-specific inputs for genre and setting, generate prompts for a generative artificial intelligence model, present the resulting ideas to the user, collect and analyze user feedback including emotional information, and then regenerate, adjust, and improve the ideas based on such analysis so as to provide higher-quality and more user-aligned creative ideas.

### SUMMARY

In order to solve the above-described problems, an embodiment of the present invention provides a system comprising a processor configured to provide, to a user, an interface for inputting a genre and a setting of a creative work, to analyze the input genre and setting to generate a prompt that instructs a generative artificial intelligence model to generate a story structure and character ideas, and to receive, from the generative artificial intelligence model, generated ideas including the story structure and the character ideas. The processor is further configured to provide the generated ideas to the user through the interface, to receive feedback on the generated ideas from the user through the interface, and to perform sentiment analysis on the feedback received from the user. In some embodiments, the processor is configured to receive additional input from the user as a prompt and, based on the additional input, regenerate, adjust, and improve the generated ideas. In other embodiments, the processor is configured to analyze emotional information of the user based on the sentiment analysis of the feedback, to re-evaluate a quality of the generated ideas based on a result of the analysis of the emotional information, and to further improve the generated ideas based on an evaluation result of the re-evaluation of the quality. By these means, the system can adaptively refine the story structure and character ideas in accordance with both explicit user input and implicitly derived emotional information, thereby providing creative ideas that are better aligned with the user's intentions and emotional satisfaction.

The term “system” refers to an aggregation of hardware and software components, including at least one processor and associated memory and interfaces, configured to execute the processing described in the claims.

The term “processor” refers to one or more hardware processing units, such as a central processing unit (CPU), a graphics processing unit (GPU), or other execution circuitry, which execute instructions to perform the functions specified in the claims.

The term “interface” refers to a hardware and/or software component, such as a graphical user interface, web interface, or application programming interface, that enables a user to input information and receive output from the system.

The term “user” refers to a person or an entity that operates the interface to provide inputs such as a genre, a setting, and feedback, and that receives and reviews ideas generated by the system.

The term “genre” refers to a category or type of creative work, such as mystery, fantasy, science fiction, romance, or any other classification that defines stylistic or thematic characteristics of a story.

The term “setting” refers to descriptive information specifying the environment, time period, location, world, or contextual background in which a creative work or story is intended to take place.

The term “creative work” refers to any narrative or content to be created by the user, including but not limited to stories, novels, scripts, game scenarios, or other forms of fictional or narrative media.

The term “prompt” refers to text or structured data generated by the processor that is provided as input to a generative artificial intelligence model, and that specifies conditions, constraints, or instructions for generating story structures and character ideas.

The term “generative artificial intelligence model” refers to a machine learning model, such as a neural network-based language model, configured to generate text or other content in response to an input prompt.

The term “story structure” refers to an outline, storyline, plot framework, or sequence of narrative events that defines the overall progression of a story generated for the creative work.

The term “character ideas” refers to descriptions or concepts of fictional persons or entities, including their roles, attributes, relationships, and narrative functions within the story structure.

The term “generated ideas” refers collectively to the outputs produced by the generative artificial intelligence model, including at least the story structure and the character ideas, and optionally other narrative elements.

The term “feedback” refers to responses, comments, evaluations, or additional instructions provided by the user through the interface regarding the generated ideas, including indications of preference, satisfaction, or desired changes.

The term “sentiment analysis” refers to a computational process performed by the processor that analyzes textual or other forms of user feedback to determine emotional tone, polarity, or attitude, such as positive, negative, or neutral sentiment.

The term “emotional information” refers to data representing the inferred emotional state, attitude, or feelings of the user, derived from the sentiment analysis of the feedback.

The term “quality of the generated ideas” refers to an assessment of the generated ideas in terms of factors such as appropriateness to the specified genre and setting, coherence, creativity, novelty, and user satisfaction.

The term “additional input” refers to further instructions, constraints, preferences, or modifications provided by the user after initial ideas have been generated, which are used by the processor as a new or updated prompt.

The term “regenerate” refers to the action of causing the generative artificial intelligence model to produce new or revised generated ideas based on an updated prompt or additional input.

The term “adjust” refers to the modification of existing generated ideas, such as refining the story structure or character ideas, in response to user feedback or analysis results, without necessarily completely replacing the original ideas.

The term “improve” refers to altering the generated ideas so as to increase their assessed quality, relevance, or alignment with user preferences and emotional information, including but not limited to regenerating or adjusting elements of the ideas.

The term “re-evaluate” refers to performing a subsequent evaluation of the quality of the generated ideas, taking into account new information such as emotional information derived from user feedback.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

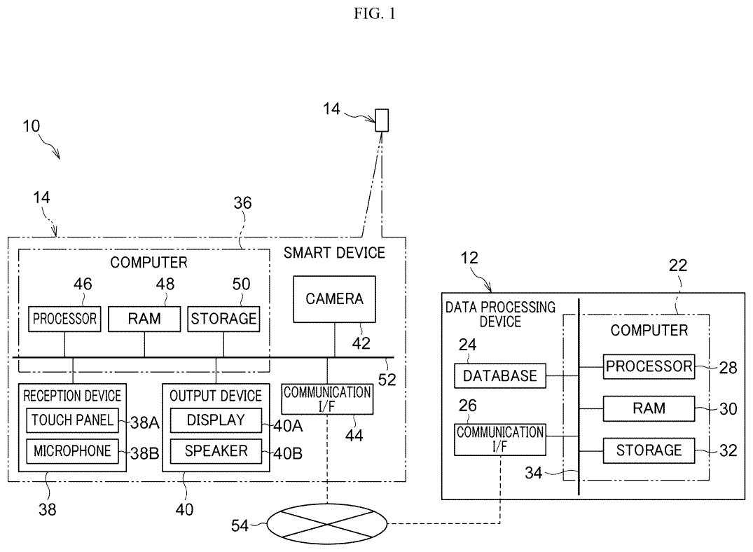

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

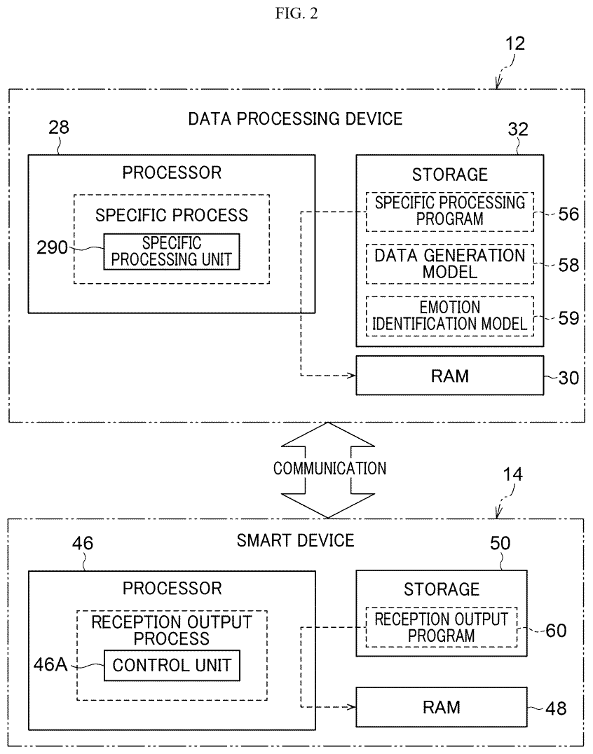

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented creative support systems generally treat a generative AI model as a black-box text generator that simply returns candidate ideas in response to a static user query. Such systems suffer from several technical limitations in how they represent, transform, and utilize user input and feedback within a computing environment. For example, typical systems directly forward unstructured user input text to a model without converting it into a structured internal representation or without generating a well-formed, model-specific prompt sentence. As a result, the model input is often ambiguous or redundant, which leads to unstable or low-quality outputs and requires repeated manual trial-and-error by the user, thereby increasing processing time and resource consumption on both client and server devices.

Furthermore, conventional systems do not effectively integrate user feedback and emotion information into the computational pipeline. User feedback, including implicit or explicit emotion information, is either ignored or used only for coarse-grained logging, and is not used in real time to adjust prompt sentences, model operating conditions, or presentation data. Consequently, the system cannot adaptively control the generative AI model based on the user's reaction, and the server must repeatedly execute similar generation processes, increasing the number of network round trips, the amount of model calls, and the associated processing load.

In addition, conventional systems often lack a clearly defined transformation flow from user input to structured data, from structured data to a natural language prompt sentence, and from model output to presentation data suitable for a user interface. This absence of well-defined data processing stages makes it difficult to optimize intermediate representations, to standardize interfaces among software components, and to reduce unnecessary data transfer and post-processing overhead. The lack of such technical structuring also inhibits effective reuse of intermediate data when users request iterative refinement of ideas.

Accordingly, there is a need for a computer-implemented system and method that improves the internal data processing pipeline surrounding a generative AI model, in particular by (i) converting user input into structured data and then into optimized prompt sentences, (ii) systematically transforming model output into presentation data, and (iii) analyzing user evaluation and emotion information to automatically adjust at least one of the prompt sentence, the model operating conditions, and the presentation data. Such a system should improve the efficiency and reliability of the idea generation process, reduce redundant model invocations, and enhance the technical performance of the server-side processing as a whole.

The specific processing by the specific processing unit 290 of the data processing device 12 in Example 1 is realized by the following means.

The present invention provides a server comprising a processor configured to provide an information input/output unit that receives, from a user terminal over a communication network, work attribute information and environment information related to a creative work, convert the received work attribute information and environment information into structured data, generate a natural language prompt sentence based on the structured data, supply the prompt sentence as model input to a generative AI model, obtain story structure information and character information output from the generative AI model, convert the obtained story structure information and character information into presentation data, transmit the presentation data to the user terminal, and further analyze evaluation information and emotion information received from the user terminal with respect to the presentation data to change at least one of contents of the prompt sentence and operating conditions of the generative AI model based on a result of the analysis. This enables the server to execute a technically structured sequence of data transformations that optimizes model input and output, reduces redundant processing and communication overhead, and adaptively controls the generative AI model in response to user reactions, thereby improving the overall efficiency, responsiveness, and quality of computer-implemented idea generation.

The term “processor” refers to one or more hardware processing units, such as a central processing unit, a graphics processing unit, or any other computation circuitry, configured to execute program instructions that implement the functions described herein.

The term “user” refers to a human operator or an entity controlling a client device that provides input information to the system and receives output information generated by the system.

The term “user terminal” refers to an information processing device, such as a personal computer, a smartphone, a tablet, or any other communication-capable apparatus, operated by the user to transmit input information to the server and receive presentation data from the server.

The term “information input/output unit” refers to a combination of hardware and software components, including communication interfaces and user interface modules, configured to receive information from the user or the user terminal and to output information to the user or the user terminal.

The term “work attribute information” refers to information that specifies characteristics of a creative work, including, for example, a genre, a theme, or a style category that classifies the work at a conceptual level.

The term “environment information” refers to information that specifies contextual settings of a creative work, including, for example, a temporal setting, a spatial setting, or a background situation in which the work is placed.

The term “structured data” refers to data that is organized according to a predefined format or schema, such as key-value pairs or a hierarchical object representation, enabling systematic processing by software components.

The term “prompt sentence” refers to a natural language instruction text generated by the processor based on the structured data and supplied to a generative AI model to control the content and style of the model's output.

The term “generative AI model” refers to a machine-learned information processing model, such as a natural language generation model or a large-scale transformer-based model, configured to generate text or other content in response to an input prompt sentence.

The term “story structure information” refers to information representing an outline, sequence, or organization of events or scenes in a narrative generated by the generative AI model.

The term “character information” refers to information representing entities that appear in a narrative, including roles, attributes, personalities, and brief background descriptions generated by the generative AI model.

The term “presentation data” refers to data formatted for output to the user, including layout information, display text, and other representation details suitable for display on the user terminal.

The term “evaluation information” refers to information indicating the user's assessment of generated content, including explicit ratings, selections, comments, or other feedback that expresses the user's preference or satisfaction.

The term “emotion information” refers to information indicating an emotional state of the user with respect to the generated content, which may be derived from explicit user input, reaction indicators, or analysis of user-provided text.

The term “operating conditions of the generative AI model” refers to parameters and control values used when executing the generative AI model, including, for example, model selection, temperature, maximum output length, and other generation-related settings.

The term “analysis” refers to a computational process performed by the processor in which input data is examined, evaluated, or transformed into derived data, including, for example, parsing, classification, sentiment determination, or quality evaluation.

The term “presentation unit” refers to hardware and software components, such as a display device and associated rendering software, configured to output presentation data to the user in a visually or otherwise perceptible form.

In one embodiment, a server cooperates with one or more terminals operated by a user to implement a computer-implemented creative support system as defined in the claims. The server includes a processor, a main memory, a non-volatile storage device, and a network interface. The terminal includes a processor, a memory, a display device, an input device such as a keyboard or touch panel, and a communication module such as a Wi-Fi module or cellular modem.

The server executes an application program on an operating system such as a general-purpose server operating system. The application program is implemented, for example, using a server-side framework such as a script-based runtime environment with an HTTP framework, or a high-level programming language with a web framework. The server further communicates with a generative AI model provided as a network-accessible service, executed on accelerator hardware such as a graphics processing unit cluster or tensor processing unit cluster in a data center.

The terminal executes a client application, which may be a web browser or a native mobile application. When the terminal runs a web browser, the client application includes HTML, CSS, and JavaScript resources delivered from the server. The terminal renders a user interface that allows the user to input work attribute information and environment information for a creative work. The user operates the terminal to enter, for example, a genre and a setting in text fields or selects such information from dropdown lists.

The terminal transmits the user's input to the server via a network using a protocol such as HTTPS. The user's work attribute information and environment information are encoded in a structured format such as a key-value object and are sent as message data in a request. The server receives this message via its network interface and passes the message to the application program.

The server parses the received message and extracts the work attribute information and environment information. The server then converts these extracted values into structured data internal to the application. In one embodiment, the server constructs an internal object that includes fields for at least a work genre, a temporal setting, a spatial setting, and a background context. The server may normalize the strings by trimming whitespace, converting character encodings, and mapping synonyms or user variants to canonical internal codes. For example, the server may map “mystery” and “detective story” to a common internal genre identifier. This structured representation enables the processor to more efficiently generate consistent prompt sentences and to perform downstream analysis without re-parsing free-form text.

The server transforms the structured data into a prompt sentence suitable for a generative AI model. The server uses a template-based algorithm that fills predefined slots in a natural language pattern. In one example, the server generates the following prompt sentence:

“Genre: mystery, setting: medieval Europe. Based on this, please generate a detailed storyline outline (3-5 main plot points) and at least three character ideas, each with a short description.”

In another example, for different attribute values, the server generates:

“Genre: fantasy, setting: a floating city in the sky. Please generate one storyline and five character ideas, including their roles, personalities, and brief backgrounds.”

The server applies deterministic string assembly rules to ensure that the prompt sentence follows a consistent structure, including explicit labels (“Genre:”, “setting:”), explicit output constraints (“3-5 main plot points”, “at least three character ideas”), and explicit formatting hints. By generating the prompt sentence from normalized structured data using a fixed template, the server reduces variability in model input and improves the reproducibility and accuracy of the model's output. This is a technical improvement over directly forwarding arbitrary user text, which often results in under-specified or inconsistent instructions.

The server transmits the generated prompt sentence to the generative AI model. In one embodiment, the generative AI model is a transformer-based neural network configured for natural language generation. The model stores a plurality of parameters (weights) that define linear transformations and attention mechanisms across multiple layers. The model processes the prompt sentence as a sequence of tokens and performs matrix multiplications and non-linear activation functions to compute contextualized representations. An attention mechanism computes relevance scores between tokens and aggregates information across the sequence. At an output layer, the model applies a probability distribution over a vocabulary to select output tokens, subject to control parameters such as temperature, maximum output length, and sampling strategy (for example, top-k or nucleus sampling). The model repeats this token generation process to produce the story structure information and character information as a sequence of natural language text.

In one embodiment, the generative AI model is trained beforehand on a corpus of textual data using a gradient-based optimization algorithm. The model training uses a loss function such as cross-entropy between the predicted token distribution and the ground truth tokens. The training process adjusts the model's weights by backpropagating gradients through the network layers and updating the weights using an optimization method such as stochastic gradient descent or an adaptive optimization algorithm. Data augmentation techniques, such as random masking or sequence shuffling, may be used during training to improve generalization. The training process yields a model that can generate coherent narratives and character descriptions in response to prompt sentences that specify genre and setting constraints.

The server receives the generated text from the generative AI model as response data. The server extracts the textual content corresponding to story structure information and character information. The server performs further processing on the generated text to divide it into sections, for example by identifying headings such as “Storyline:” or “Characters:”, or by detecting bullet patterns and line breaks. The server then constructs presentation data, which may include separate fields for a storyline outline and for a list of character descriptions, each associated with an identifier and optional metadata such as estimated complexity or length.

The server transmits the presentation data to the terminal. The terminal receives the presentation data and converts it into graphical user interface components displayed on the display device. The terminal may render the storyline in one panel and the character descriptions in another panel, with scrollable regions. The user views the generated ideas and may provide explicit evaluation information and emotion information. For example, the user may select a rating, mark certain ideas as “good” or “not suitable,” or enter free-form comments indicating which aspects they liked or disliked.

The terminal sends this evaluation information and emotion information back to the server. The server receives the feedback and analyzes it using an emotion analysis algorithm. In one embodiment, the server uses a classifier that maps user-provided text or structured ratings to an emotion label or a numerical sentiment score. The classifier may be implemented as a smaller neural network model or as a rule-based system using lexical resources. The server aggregates the evaluation information and emotion information into emotion evaluation information that captures the user's reaction to the generated story structure information and character information.

The server uses the emotion evaluation information to adjust subsequent processing. For example, if the emotion evaluation information indicates dissatisfaction with the pacing of the storyline but satisfaction with the setting, the server modifies the prompt sentence generation rules to request a different narrative structure while keeping the setting constant. The server may generate a revised prompt sentence such as:

“Genre: mystery, setting: medieval Europe. The previous storyline was too slow for the user. Based on this, please generate a faster-paced storyline with stronger tension and three new character ideas.”

In another case, if the emotion evaluation information indicates that the user prefers more complex characters, the server may alter the operating conditions of the generative AI model by increasing the maximum output length and adjusting a complexity parameter encoded in the prompt sentence. For example, the server may generate:

“Genre: mystery, setting: medieval Europe. Please generate a storyline and five character ideas with complex inner conflicts and detailed backgrounds.”

The server can iteratively refine the prompt sentences and model parameters based on the user's feedback. This iterative refinement is implemented using non-conventional processing rules that map specific feedback categories (for example, “too simple,” “too dark,” “insufficient twist”) to concrete modifications in internal structured data and prompt sentence templates. The mapping rules are encoded in the application program and operate on the structured representation of genre, setting, and prior outputs. Because these rules directly modify technical parameters of the generative AI model (such as output length constraints or narrative structure hints), the system goes beyond simple human-like editing and implements a specific machine-oriented strategy for improving output quality and computational efficiency.

The server, by maintaining structured data representations and feedback histories, avoids redundant model invocations that would otherwise occur if the user had to manually restate all conditions in free text. The server can reuse existing structured data and apply differential changes based on new feedback, reducing the size and complexity of subsequent prompt sentences while still providing sufficient context for the generative AI model. This leads to shorter model inputs, reduced network traffic between the server and the model host, and faster response times. In this manner, the system improves processing speed and decreases communication load compared with systems that only pass raw, unstructured text between user and model at each iteration.

In another embodiment, the server stores user-specific preference profiles in a database. The server updates these profiles based on accumulated evaluation information and emotion information. When a new session starts, the server initializes the structured data and prompt sentence according to the stored profile, for example by automatically including a preferred narrative tone or character archetype. This reduces the number of iterations required to reach satisfactory ideas and further improves computational efficiency. The profile is represented as a structured record containing attributes such as preferred genre distribution, typical desired complexity, and sentiment patterns, which can be directly used by the prompt generation module.

The server, in some embodiments, controls multiple generative AI models with different architectures or training data. The server selects a particular model or a combination of models based on the structured data and emotion evaluation information. For example, the server may route concise outline requests to a smaller, faster model and route detailed character backstory requests to a larger, more expressive model. This model selection is driven by algorithmic rules and can significantly improve system throughput and resource utilization, which is a technical improvement in resource management.

The terminal, in some embodiments, provides additional local processing support. The terminal may cache recent presentation data to reduce re-fetching and may perform local rendering optimizations such as pre-computing layout segments or offloading text rendering to dedicated graphics hardware. By structuring presentation data from the server into well-defined segments, the terminal can update only modified segments when the server returns revised ideas, reducing the amount of screen redraw and improving responsiveness.

In various alternative embodiments, the generative AI model may be implemented as a recurrent neural network, a convolutional neural network for text, or a hybrid architecture. The underlying training methodology may include supervised learning, unsupervised pretraining followed by supervised fine-tuning, or reinforcement learning based on human feedback. The error function used during training can be adjusted to penalize incoherent or contradictory narratives more strongly, and the server can instruct the model host to use particular decoding strategies based on the error analysis of previous outputs.

The server, by employing structured data, deterministic prompt sentence construction, and feedback-driven adjustment of model parameters, implements a non-conventional computational pipeline that improves over generic request-response systems. The causal relationship between this pipeline and the technical effects can be explained as follows: normalized structured data reduces ambiguity in model inputs, which leads to more stable and accurate outputs; deterministic templates and explicit constraints in prompt sentences reduce the search space for the generative AI model, which improves generation speed and consistency; and feedback-based adaptation of parameters and templates reduces the number of required generation cycles and network calls, which lowers latency and resource consumption. These improvements collectively enhance the functioning of the server and the terminal as machines, rather than merely automating a mental creative process.

The user, through this system, interacts with a technically optimized environment where the internal data flows, model invocation patterns, and presentation formats are specifically designed to improve computational behavior. The system is not limited to any particular business use and can be applied to various technical contexts where structured generation and adaptive control of a generative AI model are beneficial, such as automated scenario generation for simulation systems, content creation for human-machine interfaces, or narrative generation for training and education platforms.

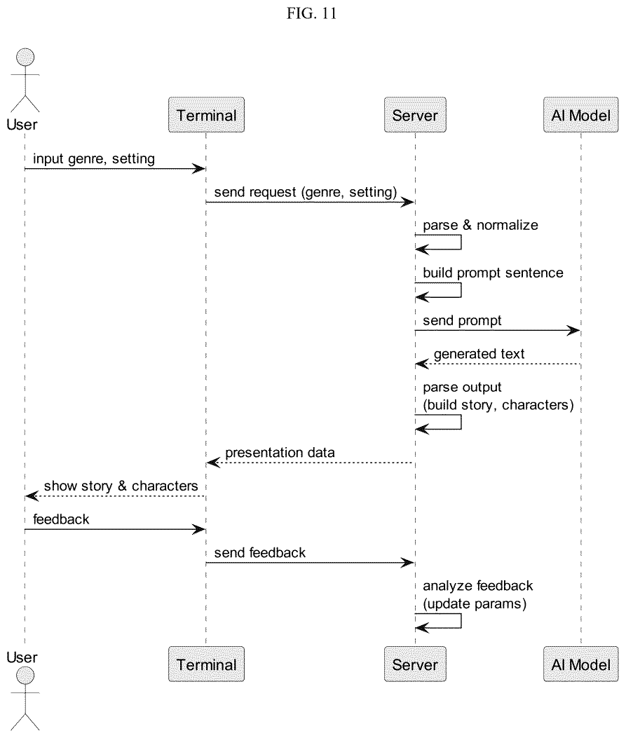

The following describes the processing flow using FIG. 11.

### Step 1

The user operates the terminal to open a client application and display an input screen.

The user inputs work attribute information and environment information (for example, a genre and a setting) into text fields or selects them from dropdown menus.

The terminal receives these user inputs as raw text values or selection identifiers. As input, the terminal obtains strings such as “mystery” for the genre and “medieval Europe” for the setting.

The terminal performs initial validation and normalization, such as trimming whitespace and converting characters to a unified encoding, and stores the cleaned values in memory as key-value pairs. As output, the terminal prepares a structured request object containing fields for the genre and the setting.

### Step 2

The terminal converts the structured request object into a transmission format suitable for network communication.

As input, the terminal uses the in-memory key-value pairs representing the genre and setting. The terminal serializes this data into a message body, for example a JSON string, and attaches metadata such as an endpoint path and HTTP headers. This processing includes string concatenation, escaping of special characters, and insertion of field names into the serialized structure.

The terminal outputs an HTTP request message containing the serialized user input and sends this message to the server over a network using a protocol such as HTTPS.

### Step 3

The server receives the HTTP request message from the terminal through a network interface.

As input, the server obtains the raw HTTP message, including the serialized body that contains the genre and setting information.

The server invokes an HTTP handling module that parses the request line, headers, and body.

The server then deserializes the body (for example, by parsing the JSON string) into an internal data structure, such as an object with fields “genre” and “setting.”

The server outputs a normalized internal representation of the user's work attribute information and environment information, ready for further processing within the application program.

### Step 4

The server validates and normalizes the internal representation of the user's input.

As input, the server uses the parsed object containing the genre and setting fields.

The server checks that required fields are present, that each field is of the correct data type, and that string lengths are within predefined limits. The server may further map user-provided labels to canonical internal codes, for example mapping both “mystery” and “detective” to a common genre identifier, and mapping “medieval Europe” to a predefined environment code.

The server outputs a refined structured data object in which work attribute information and environment information are represented by canonical identifiers and cleaned text, enabling deterministic downstream processing.

### Step 5

The server generates a prompt sentence based on the structured data object.

As input, the server uses the canonical genre identifier, the canonical environment identifier, and any associated textual labels.

The server applies a template-based algorithm that assembles a natural language instruction by inserting the genre label and setting label into fixed sentence patterns. This processing includes string concatenation, insertion of colon-separated labels (for example, “Genre:” and “setting:”), and attachment of explicit output constraints such as the number of plot points or characters to be generated.

The server outputs a prompt sentence, for example: “Genre: mystery, setting: medieval Europe. Based on this, please generate a detailed storyline outline (3-5 main plot points) and at least three character ideas, each with a short description.”

### Step 6

The server constructs a model input payload for the generative AI model.

As input, the server uses the generated prompt sentence and a set of model control parameters such as maximum output length and temperature.

The server encodes the prompt sentence into a model-specific message structure, which can include tokenization or text field placement, and attaches the control parameters to this structure. The server may also add context identifiers or session identifiers to maintain continuity between multiple requests.

The server outputs a model input payload that encapsulates the prompt sentence and generation parameters, formatted according to an interface definition for the generative AI model.

### Step 7

The server sends the model input payload to the generative AI model and receives the generated text.

As input, the server uses the prepared payload.

The server transmits the payload over a communication channel (for example, HTTPS) to a model host service. The generative AI model processes the prompt sentence by converting it into tokens, applying matrix multiplications and attention computations across multiple network layers, and sampling output tokens according to the specified parameters.

The server receives, as output, response data that includes generated text representing story structure information and character information.

### Step 8

The server parses and structures the output from the generative AI model.

As input, the server uses the response data that contains the generated text.

The server extracts the text field from the response structure and applies text processing, such as splitting the text into paragraphs, detecting labels (for example, “Storyline:” or “Characters:”), and identifying list markers or numbering that indicate separate plot points or separate characters.

The server outputs a structured representation of the model output, such as a list of plot point strings and a list of character description strings, each associated with indices and optional metadata.

### Step 9

The server converts the structured model output into presentation data suitable for display on the terminal.

As input, the server uses the lists of plot points and character descriptions with their associated metadata.

The server formats these lists into a presentation structure that may include headings, ordered or unordered lists, and text segments prepared for rendering by a client application. The server may also embed layout hints, such as grouping plot points into a single section and characters into another section.

The server outputs a presentation data object that encapsulates the storyline information and character information in a form optimized for client-side display.

### Step 10

The server sends the presentation data to the terminal.

As input, the server uses the presentation data object.

The server serializes this object (for example, into JSON), attaches appropriate response headers, and issues an HTTP response containing the serialized data.

The terminal receives, as output from the server, the response message containing the presentation data.

### Step 11

The terminal parses the presentation data and updates the user interface.

As input, the terminal uses the response message received from the server.

The terminal deserializes the message body back into an internal data structure, extracting the storyline section and the character section. The terminal then performs DOM manipulation or equivalent view updates, for example, by setting the text content of designated areas on the display and creating list items for each plot point and each character description.

The terminal outputs an updated screen image on the display device, showing the generated storyline and character ideas to the user.

### Step 12

The user reviews the generated ideas and provides evaluation information and emotion information.

As input, the user uses the displayed storyline and character information.

The user interacts with GUI elements such as rating controls, preference toggles, or comment fields to indicate satisfaction or dissatisfaction with aspects of the output. The user may also enter free-text reactions, such as “too slow” or “characters are not complex enough.”

The terminal collects these user inputs and outputs a feedback object containing evaluation information and emotion-related text to be sent to the server.

### Step 13

The terminal transmits the feedback object to the server.

As input, the terminal uses the collected evaluation information and emotion information.

The terminal serializes the feedback object and sends it in a network request to a designated feedback endpoint on the server. This processing includes attaching a session identifier so that the server can associate the feedback with the corresponding generated content.

The terminal outputs an HTTP feedback request message addressed to the server.

### Step 14

The server receives and analyzes the feedback to update internal parameters.

As input, the server uses the feedback request message containing evaluation information and emotion information.

The server parses and deserializes the message, then applies analysis algorithms to determine emotion evaluation information, such as a sentiment score or a set of categorical labels (for example, “too simple,” “too slow,” “needs more tension”). Based on these results, the server modifies stored structured data or prompt generation parameters, such as increasing the desired complexity level or adjusting narrative pacing constraints.

The server outputs updated internal state parameters and modified prompt generation rules, which will be used as input in subsequent prompt sentence generation and model invocation cycles.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content generation systems that utilize generative AI models generally treat user input as a simple, static text prompt and return unstructured generated text as output. Such systems often rely on manual prompt design by end users, do not adaptively learn from user reactions, and provide limited support for iterative refinement of generated ideas. As a result, these systems exhibit several technical shortcomings from a computer-technology perspective.

First, conventional systems do not systematically transform heterogeneous user input (for example, genre, background, theme, and modification requests) into structured internal data and a standardized prompt sentence format optimized for machine processing. Without such structured processing, the generative AI model may produce unstable or inconsistent output, and the computing resources of the model and the server may be used inefficiently.

Second, conventional systems typically output a single undifferentiated character string from the generative AI model and present it directly to the user. Because the output is not automatically segmented into logical regions such as story structure information and appearing-entity information, subsequent processing on the server side, such as selective updating, targeted regeneration, or reuse of particular parts, is difficult. This leads to an increase in repeated full-generation operations by the generative AI model, which in turn increases computational load and network traffic and reduces throughput and responsiveness.

Third, known systems do not incorporate emotion analysis of user feedback as a control signal into the technical processing pipeline. User reactions are often captured only in an ad hoc, qualitative manner (for example, likes or comments) and are not converted into machine-usable emotion information that can be fed back to the prompt-generation logic or the parameter control of the generative AI model. Consequently, the system cannot automatically optimize the quality of generated ideas in response to user preferences and cannot reduce the number of ineffective regeneration cycles, which results in suboptimal use of processor, memory, and network resources.

Fourth, conventional systems lack a mechanism for maintaining a time series of emotion information and learning a correspondence relationship among the type and background of the work, the generated story structure and appearing-entity settings, and the user's emotional responses. Because the systems do not build and update such evaluation information in a learning manner, they cannot automatically adapt the format or content of subsequent prompt sentences to better match individual user preferences. This absence of adaptive prompt control at the system level leads to redundant interactions, increased processing latency, and poor convergence of generated content toward a user-satisfying state.

Accordingly, there is a need for a computer-implemented system that (i) converts user-provided work-related information into structured data and a standardized prompt sentence, (ii) invokes a generative AI model and post-processes the model output into structured regions suitable for programmatic handling, (iii) captures user feedback and performs emotion analysis to derive emotion information, and (iv) uses the emotion information, including its time-series accumulation, to adjust prompt content and generative AI control parameters in a learning manner. Such a system would improve the efficiency and technical performance of the overall content generation pipeline, reduce unnecessary regeneration operations, adapt generation behavior to user preferences, and thereby enhance the functioning of the underlying computer technology used for interactive content creation.

The specific processing by the specific processing unit 290 of the data processing device 12 in Application Example 1 is realized by the following means.

The present invention provides a server comprising a processor configured to provide, via a display device and an input device, an interface through which a user inputs character information regarding at least a type of a work and a background of the work, to generate structured data including the character information and to generate, based on the structured data, a prompt sentence formatted according to a predetermined format, to transmit, via a communication interface, request data including the prompt sentence to an external generative information processing apparatus so as to cause a generative AI model executed by the external generative information processing apparatus to generate ideas regarding a structure of a story and settings of appearing entities, to acquire response data from the generative AI model and to analyze character string data included in the response data so as to divide the character string data into a plurality of regions including information regarding the structure of the story and information regarding the appearing entities and thereby generate structured output data, to convert the structured output data into display data in a presentation format and to present, via the display device, the ideas regarding the structure of the story and the settings of the appearing entities to the user, to acquire, via the input device, feedback information representing a reaction of the user to the presented ideas and to perform an emotion analysis process that extracts emotion information of the user from the feedback information, and to calculate, based on the emotion information, an evaluation value of the generated ideas and to change, in accordance with the evaluation value, at least one of contents of the prompt sentence and control parameters for the generative AI model and to instruct the generative AI model to perform a regeneration process using a modified prompt sentence, and further configured to store, in a storage device, a time series of the emotion information, to update, in a learning manner, evaluation information indicating a correspondence relationship among the type of the work, the background of the work, and at least one of the generated structure of the story and the generated settings of the appearing entities and the emotion information, and to automatically adjust, based on the evaluation information, at least one of a format and contents of a subsequently generated prompt sentence so as to adapt a tendency of idea generation by the generative AI model to preferences of the user. This enables the server to implement a technically improved content generation pipeline in which user input is converted into structured data and an optimized prompt sentence, responses from the generative AI model are normalized into structured regions suitable for machine processing, user feedback is transformed into emotion information that serves as a control signal for prompt and parameter adjustment, and time-series emotion information is exploited to learn and apply evaluation information, thereby reducing unnecessary regeneration operations, improving resource utilization and responsiveness, and adaptively converging generated ideas toward content that matches user preferences.

The term “processor” refers to one or more hardware processing circuits, such as a central processing unit, a graphics processing unit, or a programmable logic device, configured to execute program instructions to perform the functions described herein.

The term “display device” refers to any output apparatus that visually presents information to a user, including but not limited to a liquid crystal display, an organic light emitting diode display, or a projection display.

The term “input device” refers to any apparatus that receives user input, including but not limited to a touch-sensitive panel, a keyboard, a pointing device, a microphone, or a camera.

The term “interface” refers to a combination of hardware and software components that enables interaction between the user and the system, including graphical user interfaces, command interfaces, and forms for inputting and viewing information.

The term “character information” refers to information represented as a sequence of characters or symbols, including textual data expressing a type of a work, a background of a work, or other work-related attributes.

The term “type of a work” refers to a classification or category of a creative work, such as a genre of a story, a style of a narrative, or a general kind of content to be generated.

The term “background of the work” refers to contextual information describing a setting or environment of a work, including at least a time, place, situation, or world view in which a story takes place.

The term “work-related information” refers to information provided by a user that is used for generating or modifying a creative work, including at least a type of a work, a background of the work, themes, constraints, and modification requests.

The term “structured data” refers to data organized according to a predefined format or schema, such as a record, a table, or a hierarchical object, in which individual elements, including a type of a work and a background of the work, are represented by identifiable fields.

The term “prompt sentence” refers to a text string or a set of text strings generated in accordance with a predetermined format and provided as input to a generative AI model to control or condition the behavior of the generative AI model.

The term “predetermined format” refers to a predefined structural and syntactic arrangement of data or text, including fixed phrases, labels, and ordering rules, used to standardize prompt sentences for use by a generative AI model.

The term “communication interface” refers to hardware and software components that enable data exchange between the system and an external apparatus over a communication network, including wired and wireless interfaces and associated protocols.

The term “external generative information processing apparatus” refers to a computing apparatus that is separate from the system and that executes a generative AI model to generate output data in response to input data, such as a remote server or a cloud-based computing environment.

The term “generative AI model” refers to a machine-learned model that generates output data, such as text representing ideas or content, based on input data including a prompt sentence, and that is typically implemented using a neural network or other probabilistic model.

The term “request data” refers to a data structure transmitted from the system to an external generative information processing apparatus and including at least a prompt sentence and optional control parameters for the generative AI model.

The term “response data” refers to a data structure received from the external generative information processing apparatus and including at least character string data representing generated ideas or content produced by the generative AI model.

The term “character string data” refers to data representing one or more sequences of characters that form natural language text or symbolic expressions generated by the generative AI model.

The term “structure of a story” refers to information indicating an outline or progression of a narrative, including at least a beginning, development, and conclusion, and optionally intermediate events or scenes.

The term “appearing entities” refers to characters, objects, or other actors that play roles within a story, including their attributes, relationships, and roles in the narrative.

The term “structured output data” refers to data generated by parsing and organizing character string data from the generative AI model into multiple identifiable regions, including at least a region for story structure information and a region for appearing-entity information.

The term “region” refers to a logically or structurally distinct portion of data within a larger data structure, such as a segment of text or a field of a record, that is associated with a particular type of information.

The term “display data” refers to data formatted for presentation to a user via a display device, including layout, headings, and visual structures derived from structured output data.

The term “feedback information” refers to information acquired from a user that represents a reaction or evaluation of presented ideas, including explicit evaluations, selection operations, textual comments, or other interaction signals.

The term “emotion analysis process” refers to a computation that processes feedback information to infer emotion information of a user, such as satisfaction, interest, or disappointment, using rule-based or machine-learning-based techniques.

The term “emotion information” refers to data representing an inferred emotional state or response of a user, including quantitative scores, categories, or labels derived from the emotion analysis process.

The term “evaluation value” refers to a quantitative or qualitative metric calculated based on emotion information that indicates a degree of suitability, quality, or preference regarding generated ideas.

The term “control parameters for the generative AI model” refers to one or more adjustable values that influence operation of the generative AI model, including but not limited to temperature, maximum output length, sampling strategy, and weighting of specific behaviors.

The term “regeneration process” refers to a process in which the generative AI model generates new ideas or content using a modified prompt sentence or changed control parameters in response to prior evaluation results.

The term “additional work-related information” refers to work-related information provided by the user in addition to initial work-related information, including further constraints, additional themes, or new descriptive elements for a work.

The term “modification request” refers to information provided by the user that specifies desired changes to previously presented ideas, such as adding, removing, or altering elements of the story structure or appearing entities.

The term “updated prompt sentence” refers to a prompt sentence that has been modified by appending or replacing at least part of the original prompt sentence with additional work-related information or a modification request.

The term “storage device” refers to any non-transitory computer-readable medium configured to store data, including semiconductor memory, magnetic storage, or optical storage.

The term “time series of the emotion information” refers to a sequence of emotion information elements associated with different points in time or different interactions, stored in chronological order.

The term “evaluation information” refers to data that represents a correspondence relationship among a type of a work, a background of the work, at least one of a generated structure of a story and generated settings of appearing entities, and emotion information, and that is used to guide subsequent prompt generation or parameter control.

The term “learning manner” refers to a process in which evaluation information is progressively updated based on accumulated data, including statistical analysis, parameter estimation, or machine learning techniques, so that future processing adapts to observed patterns.

The term “format of a prompt sentence” refers to structural aspects of a prompt sentence, including ordering of segments, inclusion or omission of particular fields, and style of instructions given to the generative AI model.

The term “contents of a prompt sentence” refers to the specific textual content included in a prompt sentence, including particular values of work-related information, descriptive phrases, and control instructions directed to the generative AI model.

The term “tendency of idea generation” refers to characteristic patterns of output produced by the generative AI model, such as typical themes, complexity, tone, or level of detail, when conditioned by particular prompts and control parameters.

The term “preferences of the user” refers to characteristics of ideas or content that are favored or disfavored by a particular user, as inferred from emotion information, feedback information, and historical interaction data.

In one embodiment, a server, a terminal, and a user cooperate to implement the invention.

The server includes a processor, a storage device, a communication interface, and a memory storing executable software components. The server is implemented, for example, as a virtual machine or container instance running on a general-purpose computer platform such as a rack-mounted server equipped with a multi-core central processing unit and one or more graphics processing units. The server executes an operating system such as a general-purpose server operating system, and application software implemented using a server-side framework such as a web application framework. The server further includes a generative AI client module configured to communicate with an external generative AI model hosted on a separate computing environment, for example a cloud-based neural network service.

The terminal includes a processor, a display device, an input device, a communication interface, and a local storage device. The terminal is implemented, for example, as a smartphone, a tablet computer, or a head-mounted display device. The terminal executes an operating system such as a mobile operating system and runs a dedicated application providing a graphical user interface (GUI) that allows the user to input work-related information and view generated ideas. The terminal application is implemented, for example, using a cross-platform framework such as a mobile application framework and uses a networking library to perform HTTP communication with the server.

The user uses the terminal to provide work-related information, such as a type of a work and a background of the work, and to evaluate generated ideas. The user interacts with GUI elements on the terminal, including text fields, drop-down lists, buttons, and scrolling views. The server stores program modules configured to perform at least the following functions: user interface coordination, work-information structuring, prompt sentence generation, generative AI model invocation, output parsing and structuring, display-data formatting, feedback acquisition and emotion analysis, evaluation-information learning, and adaptive prompt control.

The server uses the work-information structuring module to convert user-provided character information into structured data. The server represents the structured data as a record or object including explicitly labeled fields, such as “work_type”, “work_background”, “theme”, “constraints”, and “modification_request”. The server stores the structured data in a database or in-memory data structure. This explicit structuring enables the server to programmatically construct prompt sentences and to selectively reuse portions of the data in subsequent regeneration operations, thereby improving data management and reducing computational redundancy.

The server uses the prompt sentence generation module to transform the structured data into a standardized prompt sentence that will be consumed by the generative AI model. The server employs a template-based algorithm in which fixed segments and labels are combined with variable segments derived from user input. For example, the server generates prompt sentences such as:

“Genre: Science fiction, Setting: future city. Additional notes: Robots and humans should appear. Based on this, please generate a short-story storyline and two or more main characters, including their roles and personalities.”

“Genre: Fantasy, Setting: a kingdom on the brink of civil war. Additional notes: Include a reluctant hero and a political conspiracy. Based on this, please generate a short-story outline (beginning, middle, end) and at least three main characters, including their names, roles, and personalities.”

“Genre: Mystery, Setting: small seaside town. Based on this, please generate an incident outline, a culprit's motive, main clues, and brief profiles of five characters.”

The server applies rules for ordering, inclusion, and phrasing of fields in the prompt sentence so that the generative AI model receives a stable and optimized conditioning context. This standardized prompt format reduces variability in model behavior and leads to more predictable output structures, which in turn facilitates automated parsing and resource-efficient post-processing.

The server communicates with an external generative AI model running on a generative information processing apparatus. The generative AI model is implemented as a neural network, for example a Transformer-based language model comprising multiple self-attention layers, feed-forward layers, and normalization layers. The generative AI model receives tokenized representations of the prompt sentence, applies learned weight matrices, and computes a probability distribution over possible next tokens using a softmax function. The generative AI model uses decoding algorithms such as temperature-controlled sampling or top-k sampling to produce sequences of tokens that form natural-language text representing a story structure and appearing-entity settings.

The server uses a generative AI client module to send the prompt sentence, together with control parameters such as temperature, maximum output length, and sampling strategy, to the generative AI model via the communication interface. The server configures these control parameters according to internal policies or based on learned evaluation information, as described below. By explicitly controlling such parameters, the server shapes the generative behavior of the model in a non-default, system-specific manner, thereby achieving more efficient convergence to user-preferred outputs and reducing the number of ineffective generation cycles.

The generative AI model is trained in advance using a large corpus of text data. During training, the generative AI model minimizes a loss function, such as cross-entropy loss between predicted token distributions and ground-truth tokens. The model updates its weights using gradient-descent-based optimization algorithms, such as stochastic gradient descent or adaptive moment estimation. The training involves iterative forward and backward passes through the network, with batched input sequences, and may incorporate regularization and data augmentation techniques such as dropout, random masking, or input perturbation. These training details ensure that the generative AI model has learned rich contextual representations, which the server can exploit for flexible content generation.

The server receives response data from the generative AI model, including character string data forming one or more paragraphs of generated text. The server uses the output parsing and structuring module to analyze this character string data. The server applies pattern-based and rule-based segmentation, for example by searching for keywords such as “Storyline:”, “Characters:”, “Outline:”, or by detecting enumerated lists and paragraph boundaries. The server divides the character string data into regions, such as a region corresponding to the structure of the story and one or more regions corresponding to appearing entities and their attributes. The server then constructs structured output data, for example representing each character as an element with fields such as “name”, “role”, and “personality”. This structured representation permits selective regeneration (for example, regenerating only characters while reusing a storyline) and targeted optimization, reducing the computational cost of future interactions.

The terminal receives the structured output data or display-ready data from the server and renders it such that the user can visually distinguish story structure information from appearing-entity information. The terminal displays the story outline in a main text area and presents characters in a list form with clearly labeled attributes. By structuring data before presentation, the server enables the terminal to implement efficient user interface operations, such as expanding or collapsing sections, editing specific characters, or highlighting segments affected by later regenerations.

The server acquires feedback information from the user via the terminal. The user can provide explicit feedback, such as selecting a satisfaction level from a scale, pressing buttons indicating “like”, “dislike”, “more detail”, or entering free-text comments. The terminal sends this feedback information to the server as structured data, including fields indicating which part of the generated ideas (storyline or specific character) is being evaluated, and the type and strength of the feedback.

The server uses the emotion analysis module to transform feedback information into emotion information. The server applies one or more algorithms, including a rule-based mapping (for example, mapping star ratings or like/dislike flags to satisfaction scores) and a statistical or learned classifier. In one embodiment, the server uses a separate machine-learned model, such as a lightweight neural network or logistic regression model, to process features extracted from free-text comments, interaction logs (for example, time spent reading each section, scrolling behavior), and explicit evaluation scores. The server defines feature vectors including, for example, normalized rating values, comment length, polarity of sentiment inferred from comment text, and section identifiers. The server then computes emotion information, such as a scalar satisfaction score or a vector of emotion labels, for each generated idea or subcomponent.

The server stores emotion information in the storage device in association with work type, work background, generated story structure, and generated appearing-entity settings. The server maintains a time series of emotion information across multiple interactions with the same user and across multiple users. The server constructs and updates evaluation information that expresses a correspondence relationship between input conditions (such as genre, setting, and constraints), generated output characteristics (such as narrative complexity, tone, and number of characters), and observed emotion information. The server can implement this evaluation information as a parameterized model, for example a matrix of weights or a small neural network that predicts expected satisfaction scores from input features. The server updates the parameters using online learning methods, such as incremental gradient updates, thereby progressively refining its estimates as more interaction data becomes available.

The server uses the adaptive prompt control module to adjust future prompt sentences and generative AI control parameters based on the evaluation information. For example, if the evaluation information indicates that a particular user consistently provides high satisfaction scores when character descriptions are more detailed and the story structure contains three clearly separated acts, the server modifies the prompt sentence template for that user so as to request more detailed character attributes and an explicit “beginning, middle, and end” structure. The server also adjusts control parameters such as temperature and maximum output length to favor longer, more detailed outputs. Conversely, if the evaluation information indicates that the user prefers concise outputs, the server reduces maximum output length and omits requests for excessive detail. This adaptation is not merely a shortcut for human manual prompt tuning; it constitutes a systematic algorithmic process that operates over quantitatively represented evaluation information, which a human could not efficiently compute or apply across large volumes of interactions.

The server thereby improves the technical performance of the overall system. By learning from emotion information and adjusting prompt sentences and control parameters, the server reduces the number of generation attempts that yield low satisfaction and require full regeneration. This leads to fewer calls to the generative AI model, reduced network traffic, and lower computational load on both the server and the external generative information processing apparatus. The server further minimizes latency, because subsequent generations are more likely to match user preferences on the first or second attempt. These effects represent improvements in processing efficiency, resource utilization, and responsiveness of the computer system, beyond simply automating a human author's creative process.

In one variation, the server supports partial regeneration. The server permits the user, via the terminal, to request regeneration of only selected components, such as “regenerate only the antagonist” or “regenerate the ending portion of the storyline.” The server, using the structured output data, identifies the corresponding regions and constructs a prompt sentence that includes a fixed portion representing the unchanged parts and a variable portion indicating the part to regenerate. For example, the server generates a prompt sentence such as:

“Existing storyline: [fixed outline text]. Please keep this storyline unchanged. Regenerate only the antagonist character, providing a new name, background, and motive that better fit the existing storyline.”

By constraining the generative AI model using previously generated and accepted content, the server avoids regenerating entire stories and thereby achieves communication-load reduction and computation-load reduction. The server's ability to isolate and address individual regions is a direct result of the structured parsing and representation of output data, which is a technical data-management improvement.

In another variation, the server employs alternative generative AI models or hybrid architectures. The server may use a primary Transformer-based language model for global structure generation and a secondary, smaller neural network or rule-based module for local refinement, such as enforcing consistency of character attributes or correcting narrative inconsistencies. The server may combine outputs from multiple models by applying scoring rules or ensemble methods. For example, the server may generate multiple candidate endings with different decoding parameters and select the candidate whose predicted satisfaction score, computed by an evaluation model trained on past emotion information, is highest. This selection process reduces the probability of generating unsatisfactory endings, again improving computational efficiency and perceived quality.

In a further embodiment, the server performs pre-and post-processing using domain-specific rules that humans cannot feasibly apply at the same scale. The server maintains a library of pattern rules for story structure and character archetypes, encoded as machine-readable templates and regular expressions. The server applies these rules to validate and normalize outputs from the generative AI model, for example checking that a generated “mystery” story includes at least a crime, a culprit, and clues, or that a “science fiction” story includes at least one speculative technological element. The server modifies prompt sentences to include missing required elements when evaluation information and rule checking indicate deficiencies. These rule-based, non-conventional processing sequences allow the system to enforce structural constraints in a way that improves output consistency and reduces the need for manual correction.

The terminal plays an active role in achieving the technical effects. The terminal locally validates user input (for example, checking maximum length, required fields, and allowed character sets) before transmitting data to the server. This reduces erroneous or malformed data from reaching the server and the generative AI model, thereby preventing unnecessary computation. The terminal also manages caching of previously received structured output data, enabling quick re-display without re-fetching or re-generating content. The terminal may perform local diff-rendering to visually highlight regenerated regions, based on identifiers included in the structured output data, which improves user comprehension and reduces the cognitive load associated with evaluating changes.

The user, by interacting with the terminal and server as described, benefits from a system that not only generates creative ideas but also leverages computer-technical improvements to manage data structures, model interactions, and network communication. The user does not need to understand prompt-engineering techniques or manage complex model parameters manually; instead, the server algorithmically derives and refines these elements using emotion information and evaluation information. The causal relationship between this algorithmic adaptation and the observed improvements in processing efficiency, accuracy of preference matching, and reduction in computational overhead demonstrates that the invention provides more than an abstract idea; it provides a specific, technological solution implemented through concrete data structures, processing modules, and model-control mechanisms operating within and across computer systems.

Alternative embodiments may vary in underlying hardware, software frameworks, or generative AI architectures, while remaining within the scope of the claims. The server may be implemented as a cluster of physical machines or as a serverless configuration distributing functions across multiple nodes. The generative AI model may be deployed locally on the server rather than on an external apparatus, with the same structured prompt and evaluation control mechanisms applied. The emotion analysis model may use different feature sets or learning algorithms, such as decision trees, support vector machines, or deep neural networks, provided that it outputs emotion information used by the evaluation-information learning and adaptive prompt control modules. In all such variations, the server, the terminal, and the user cooperate in a manner that results in improved computer-technical operation of the content generation pipeline, including reduced communication overhead, improved calculation efficiency, enhanced data management, and more accurate convergence to user-preferred generated ideas.

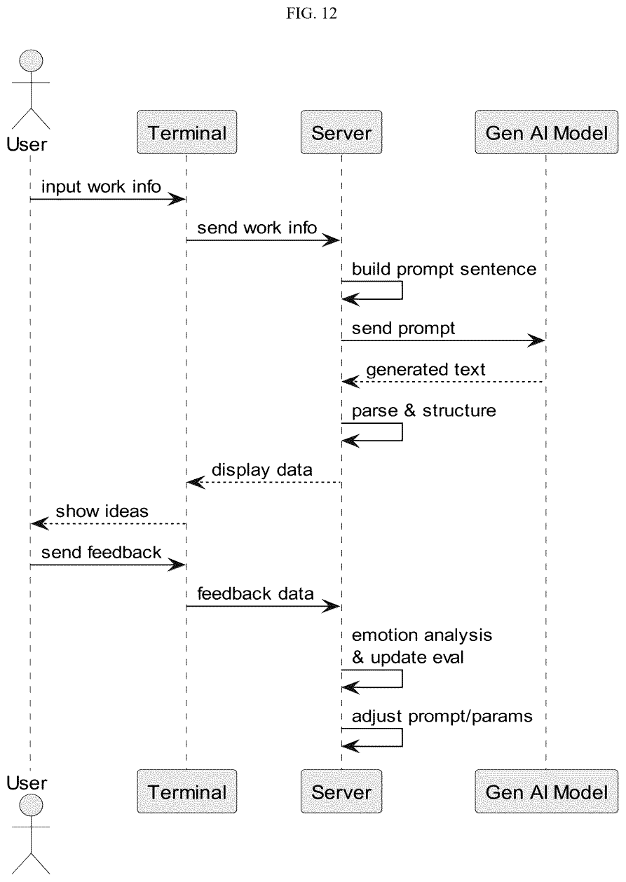

The following describes the processing flow using FIG. 12.

### Step 1

The terminal displays an input screen that allows the user to enter work-related information, such as a type of a work and a background of the work.

The input of Step 1 is an empty or default GUI state on the terminal, including text fields and selection controls without user-provided values.

The output of Step 1 is a populated GUI state containing character information typed or selected by the user, such as “Genre: Science fiction” and “Setting: future city.”

The terminal renders the GUI using a user-interface framework, receives keystrokes and touch events from the user, and writes the entered text into internal variables associated with the input fields.

### Step 2

The terminal validates the work-related information entered by the user and converts it into structured data.

The input of Step 2 is the raw character information held in the terminal's UI components, such as strings from the genre and setting fields.

The output of Step 2 is a structured record or object that includes fields for the type of the work, the background of the work, and optional attributes such as theme or constraints.

The terminal checks that required fields are non-empty, enforces maximum length limits, and filters disallowed characters. The terminal then creates a data structure (for example, an object with keys “work_type” and “work_background”) and assigns the validated string values to those keys.

### Step 3

The terminal transmits the structured work-related information to the server via a communication interface.

The input of Step 3 is the structured data object generated in Step 2 and a target network endpoint associated with the server.

The output of Step 3 is a network message, for example an HTTP request, containing serialized work-related information that is delivered to the server.

The terminal serializes the structured data into a text-based format, attaches the resulting payload to an HTTP request, sets headers such as content type and authentication tokens, and sends the request over a wired or wireless communication network.

### Step 4

The server receives and parses the work-related information sent from the terminal.

The input of Step 4 is the network message received at the server's communication interface, including the serialized structured data in the request body.

The output of Step 4 is a server-side data structure representing the type of the work, the background of the work, and any additional attributes, stored in memory.

The server's web application framework parses the request body, decodes the serialized data, and maps the decoded values to internal variables or object fields. The server also performs preliminary validation and logging of the received information.

### Step 5

The server normalizes the work-related information and generates a standardized prompt sentence for a generative AI model.

The input of Step 5 is the server-side data structure containing fields such as work type, work background, and optional notes or constraints.

The output of Step 5 is a prompt sentence formatted according to a predetermined template, ready to be consumed by the generative AI model.

The server trims whitespace, unifies text encoding, and applies normalization rules such as converting certain symbols or punctuation to a standard form. The server then executes a template-based routine that concatenates fixed phrases and labels with the normalized field values. For example, the server generates a prompt sentence such as:

“Genre: Science fiction, Setting: future city. Additional notes: Robots and humans should appear. Based on this, please generate a short-story storyline and two or more main characters, including their roles and personalities.”

### Step 6

The server prepares and transmits a request to the generative AI model including the prompt sentence and control parameters.

The input of Step 6 is the generated prompt sentence and a set of control parameters such as temperature, maximum output length, and sampling strategy.

The output of Step 6 is a formatted model-request message delivered to an external generative information processing apparatus executing the generative AI model.

The server embeds the prompt sentence and parameters into a request structure, serializes the structure into a protocol-compatible format, and sends the request over a secure network connection. The server's generative-AI client module manages authentication, endpoint selection, and error handling for this transmission.

### Step 7

The generative AI model processes the prompt sentence and generates character string data representing ideas for a story structure and appearing entities.

The input of Step 7 is the tokenized representation of the prompt sentence and the provided control parameters.

The output of Step 7 is a sequence of output tokens that are decoded into natural-language text, forming one or more paragraphs describing a storyline and character settings.

The generative AI model applies multiple neural network layers, including self-attention and feed-forward layers, to propagate activation values through its architecture. The model computes probability distributions over vocabulary tokens at each generation step and samples or selects tokens according to the control parameters. The resulting token sequence is then converted back to character string data.

### Step 8

The server receives and extracts the character string data generated by the generative AI model.

The input of Step 8 is the response message from the external generative information processing apparatus, including encoded output text fields.

The output of Step 8 is a raw text string stored in a server-side variable, containing the generated storyline and appearing-entity descriptions.

The server decodes the response message, accesses the relevant fields, concatenates partial segments if necessary, and produces a single or multi-part text string that represents the generated ideas.

### Step 9

The server analyzes the character string data and divides it into structured output regions.

The input of Step 9 is the raw generated text string obtained in Step 8.

The output of Step 9 is structured output data containing at least a region for story structure information and one or more regions for appearing-entity information.

The server searches for predefined labels or patterns (such as “Storyline:” or numbered character lists), identifies paragraph boundaries, and applies regular expressions or parsing rules to separate sections. The server then constructs a data structure in which each region is stored under a specific key, such as “storyline” or “characters,” and may further break down character regions into name, role, and personality fields.

### Step 10

The server converts the structured output data into display data suitable for presentation on the terminal.

The input of Step 10 is the structured output data with identified regions for story and characters.

The output of Step 10 is a formatted representation containing layout information, labels, and ordering, which the terminal can directly render on a display device.

The server adds headings, converts lists into ordered or unordered arrays, and possibly truncates or summarizes long sections based on display constraints. The server then serializes the display-ready data into a message format and attaches metadata such as identifiers for individual regions.

### Step 11

The server transmits the display data to the terminal.

The input of Step 11 is the formatted display data and a network address or session identifier corresponding to the terminal.

The output of Step 11 is a response message sent to the terminal, containing the display data as its payload.

The server writes the display data into the body of a network response, sets appropriate headers, and forwards the response via the communication interface. The server may also log the transaction and update internal state to track which version of ideas has been sent to the user.

### Step 12

The terminal receives the display data and renders the generated ideas for the user.

The input of Step 12 is the response message from the server, containing display data with story structure and appearing-entity regions.

The output of Step 12 is an updated visual screen on the terminal, showing the storyline and characters in a human-readable format.

The terminal parses the display data, maps sections to UI components, and draws text and labels on the display device. The terminal may enable scrolling, section expansion, or selection interactions for individual characters or story segments.

### Step 13

The user reviews the presented ideas and provides feedback information.

The input of Step 13 is the visual representation of the storyline and appearing entities on the terminal screen.

The output of Step 13 is explicit or implicit feedback signals, such as rating selections, like/dislike indications, edit requests, or textual comments, entered via the terminal's input device.

The user examines the content, decides which parts are satisfactory or unsatisfactory, and manipulates GUI elements (for example, tapping buttons or typing comments) to express preferences or request modifications.

### Step 14

The terminal captures the feedback information from the user and transmits it to the server.

The input of Step 14 is the user's interactions with feedback controls on the screen, including numerical ratings, button presses, and comment text.

The output of Step 14 is a structured feedback record sent to the server, indicating which regions were evaluated, the evaluation values, and any commentary.

The terminal converts the user's interactions into a data structure with fields such as “target_region_id,” “rating_value,” and “comment_text,” validates the data, and sends it as a network request to the server for further processing.

### Step 15

The server performs emotion analysis based on the feedback information to derive emotion information.

The input of Step 15 is the structured feedback record received from the terminal.

The output of Step 15 is emotion information, such as satisfaction scores or emotion labels, associated with specific regions of the generated ideas.

The server maps explicit ratings to numerical scores, extracts features from free-text comments, and applies an emotion-analysis algorithm or model. The server computes, for example, a scalar satisfaction value for the storyline and individual characters, and stores these values in association with the underlying work-related input and the generated output data.

### Step 16

The server updates evaluation information using the emotion information and historical data.

The input of Step 16 is newly computed emotion information together with previously stored time-series emotion information and associated input-output conditions.

The output of Step 16 is updated evaluation information that reflects refined correspondence relationships among work type, work background, generated content characteristics, and user emotions.

The server forms feature vectors from the combination of input conditions and output descriptors, applies an online learning algorithm (such as gradient-based updating) to adjust parameters of an evaluation model, and stores the updated model or parameter set in the storage device.

### Step 17

The server adjusts future prompt sentences and control parameters for the generative AI model based on the evaluation information.

The input of Step 17 is the evaluation information updated in Step 16 and the current or next work-related information associated with the user.

The output of Step 17 is a modified prompt template, specific parameter settings, or both, which will be applied during subsequent prompt sentence generation and model invocation.

The server consults the evaluation model to predict preferred output characteristics and then modifies rules for prompt construction (for example, adding instructions for more detailed character descriptions or simplifying the plot) and revises control parameters such as temperature, maximum output length, and sampling strategy. These updated configurations are stored and used as inputs to the prompt generation and model-request preparation steps for the next interaction.

### Step 18

The user optionally requests regeneration or refinement of specific parts of the generated ideas, and the server and terminal repeat the above processing with updated inputs.

The input of Step 18 is a regeneration or modification request from the user, specifying, for example, that only certain characters or certain portions of the storyline should be changed.

The output of Step 18 is a new cycle of processing in which the server constructs a new prompt sentence that incorporates both the fixed, previously accepted content and the requested changes, and the generative AI model generates updated ideas.

The user selects a target region for regeneration on the terminal, the terminal sends a structured regeneration request, the server merges this request with saved structured output data and evaluation-based adjustments, and the server issues a new prompt sentence to the generative AI model. The resulting updated ideas are again parsed, structured, and displayed, allowing iterative refinement guided by technical mechanisms of structured data handling, emotion analysis, and adaptive prompt control.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented idea generation systems that utilize generative artificial intelligence models generally treat user input as a one-time prompt and produce a static output. Such systems typically do not maintain a structured interaction history between the user and the model, nor do they systematically integrate user feedback and user emotion information into subsequent model inputs. As a result, the systems are unable to iteratively refine generated ideas in a controlled manner, and cannot adapt generation behavior at the system level based on the evolving state of the user interaction.

In particular, existing systems have several technical drawbacks. First, processing of prompt sentences and feedback information is usually performed in an ad hoc, stateless manner, where each model call is isolated, and no persistent association is maintained among prompt sentences, generated idea information, feedback information, and subsequent improved idea information. This leads to inefficient use of computational resources, because the generative artificial intelligence model repeatedly reconstructs context that the system itself could have tracked and managed. Second, feedback information from the user is typically handled only as additional natural language content, without structured analysis of user emotion or integration of emotion analysis results into the system's control logic. As a consequence, system-level control over generation conditions, such as adjustment of prompts or model parameters in response to user sentiment and satisfaction, is limited or absent.

Furthermore, when user feedback is not explicitly modeled as stateful data in a storage unit and is not used to reconstruct generation prompts in a systematic way, the processor cannot dynamically control the input context to the generative artificial intelligence model. This restricts the processor's ability to perform stepwise adjustment and improvement of idea information, and reduces the system's capability to converge on high-quality outputs tailored to the user. In addition, the lack of tight coupling between emotion analysis and the management of presentation order or content adjustment for idea information causes inefficiencies in human-computer interaction, increasing the number of iterative model calls and degrading overall system responsiveness and usability.

Accordingly, there is a need for an improved computer-implemented system that treats prompt sentences, generated idea information, feedback information, and emotion information as structured data objects, and that uses these data objects to manage an interaction history and to control, at the processor level, how generation prompts are constructed and how generative artificial intelligence models are invoked. There is also a need for a system that can automatically re-evaluate the quality of generated or improved idea information based on user emotion information and feedback content, and modify generation conditions and prompt structures accordingly, thereby improving the technical performance of the computer system in terms of iterative generation efficiency, output relevance, and adaptability to user state.

The specific processing by the specific processing unit 290 of the data processing device 12 in Example 2 is realized by the following means.

The present invention provides a server comprising a processor and a storage unit, the processor being configured to provide an information input/output unit through which a user inputs a prompt sentence including requirement information, analyze the prompt sentence acquired via the information input/output unit and generate a generation prompt based on the prompt sentence, cause a generative artificial intelligence model to generate idea information by inputting the generation prompt to the generative artificial intelligence model, present the idea information acquired from the generative artificial intelligence model to the user, acquire feedback information from the user as text data with respect to the idea information, reconstruct the generation prompt using the acquired feedback information and cause the generative artificial intelligence model to generate improved idea information in which the idea information is adjusted and improved by re-inputting the reconstructed generation prompt and the idea information to the generative artificial intelligence model, store, in the storage unit, the idea information and the improved idea information, and the prompt sentence and the feedback information corresponding to the idea information and the improved idea information, in association with one another, manage an interaction history with the user based on the association, perform emotion analysis on the feedback information acquired from the user, and reflect an analysis result of the emotion analysis in at least one of a presentation order and content adjustment of the idea information and the improved idea information, and further re-evaluate a quality of at least one of the idea information and the improved idea information based on user emotion information and content of the feedback information and change at least one of a generation condition for the generative artificial intelligence model and a structure of the generation prompt in accordance with a result of the re-evaluation. This enables the server to manage user interaction as structured state data, dynamically control model input context and generation conditions based on feedback and emotion analysis, reduce redundant computation in repeated model invocations, and iteratively produce idea information that is technically more relevant and better adapted to the user's evolving requirements and emotional state.

The term “system” refers to an information processing arrangement including at least one processor and one or more storage resources configured to execute programmed instructions to perform the claimed functions.

The term “processor” refers to one or more hardware computation units, such as a central processing unit or other execution circuitry, configured to execute instructions to implement the described processing, control, and data management operations.

The term “storage unit” refers to one or more non-transitory computer-readable storage media configured to store data and programs, including prompt sentences, idea information, feedback information, interaction histories, and control parameters.

The term “information input/output unit” refers to a hardware and software interface configured to receive input data from a user and present output data to the user, including, for example, a display device, a pointing device, a keyboard, a touch panel, or a network-based user interface.

The term “user” refers to a human operator or entity that interacts with the system by providing input, such as prompt sentences and feedback information, and by viewing or evaluating idea information presented by the system.

The term “prompt sentence” refers to a natural language text string or equivalent structured text data provided by the user that specifies requirement information or conditions for generating idea information.

The term “requirement information” refers to descriptive data included in a prompt sentence that indicates desired attributes, constraints, objectives, or preferences relating to content to be generated by the system.

The term “generation prompt” refers to a text or data structure derived from at least one prompt sentence and optionally other contextual information, which is formatted and arranged for input to a generative artificial intelligence model to generate idea information.

The term “generative artificial intelligence model” refers to a computer-implemented model, such as a probabilistic or neural network-based model, configured to generate text or other data in response to an input prompt, based on learned parameters obtained through training.

The term “idea information” refers to data representing at least one generated proposal, concept, or plan output by the generative artificial intelligence model in response to a generation prompt.

The term “improved idea information” refers to idea information that has been adjusted or modified by the generative artificial intelligence model based on feedback information, reconstructed generation prompts, and optionally prior idea information.

The term “feedback information” refers to text data or equivalent user-provided information that expresses an evaluation, request for change, additional requirements, or other reaction by the user to previously generated idea information.

The term “additional prompt sentence” refers to a prompt sentence that is provided after initial idea information has been generated and that includes additional requirement information or refinement instructions to further adjust or improve the idea information.

The term “interaction history” refers to data stored in association, including prompt sentences, idea information, improved idea information, feedback information, and related metadata, representing a sequence of interactions between the user and the system.

The term “association” refers to a stored logical linkage or relationship between two or more data items, such as between a prompt sentence, corresponding idea information, and corresponding feedback information, enabling retrieval and use of such items together.

The term “emotion analysis” refers to processing that estimates or classifies emotional characteristics, such as sentiment or affective state, from feedback information or other user-provided data using computational methods.

The term “emotion information” refers to data representing a result of emotion analysis, including, for example, scores, labels, or categories indicative of a user's emotional state or attitude.

The term “presentation order” refers to a sequence or arrangement in which idea information or improved idea information is output or displayed to the user by the information input/output unit.

The term “content adjustment” refers to modification of at least part of the content of idea information or improved idea information, including selection, emphasis, omission, or reformulation of information, based on control by the processor.

The term “generation condition” refers to one or more parameters or control settings used when invoking the generative artificial intelligence model, including, for example, model selection, temperature, maximum output length, or other model control parameters.

The term “structure of the generation prompt” refers to an internal organization or composition of the generation prompt, including arrangement of segments, inclusion or exclusion of context elements, and formatting of instructions or examples provided to the generative artificial intelligence model.

The term “input context” refers to a set of information, including at least one generation prompt, interaction history elements, and related metadata, that is provided to the generative artificial intelligence model as input for generating or refining idea information.

The term “dynamic control” refers to adjustment of at least one of the input context, generation conditions, or prompt structures during operation of the system in response to stored interaction history, feedback information, or emotion information.

In one embodiment, a server, a terminal, and a user cooperate to implement the invention. The server includes at least one processor and at least one non-transitory storage unit. The terminal includes at least one processor, a display, and an input device such as a keyboard or a touch panel. The user operates the terminal to provide instructions and to review information presented by the server.

The server executes an operating system, such as a general-purpose server operating system, and an application program that implements the functions described in the claims. The server is connected to the terminal via a communication network such as the Internet, and uses a communication protocol such as HTTP over TLS. The server further has access to a generative AI model running either on the same physical machine, on a specialized accelerator device such as a graphics processing unit, or on a separate computing node accessed via an application programming interface.

In one configuration, the server uses a transformer-based generative AI model as the generative AI model. The generative AI model is implemented as a deep neural network with multiple self-attention layers, feed-forward layers, and layer normalization. The generative AI model internally represents each token of a prompt sentence and other context as a high-dimensional numerical vector, and processes sequences of such vectors using attention mechanisms. The server stores learned parameters of the generative AI model, such as weight matrices for attention and feed-forward layers, in the storage unit. The server further stores metadata describing generation conditions, such as temperature, maximum token length, and top-k or top-p sampling parameters.

The server provides an information input/output unit to the terminal. The terminal presents, on its display, a graphical user interface having at least one text input field and at least one output area for showing generated content. The user operates the input device of the terminal to enter a prompt sentence. For example, the user may input the following prompt sentence:

“I want an idea for a new smartphone app.”

In another example, the user may input:

“Generate three ideas for a new smartphone app for office workers in their 30s. Each idea should focus on stress reduction.”

The terminal transmits the prompt sentence to the server. The server receives the prompt sentence and stores it in the storage unit as part of an interaction history data structure. The interaction history data structure may be implemented as records in a database table, where each record includes a user identifier, a prompt identifier, a text field for the prompt sentence, a timestamp, and links to associated idea information and feedback information. By maintaining this structured interaction history, the server avoids re-parsing and re-deriving context for each invocation of the generative AI model, thereby reducing redundant computation and improving processing speed.

The server generates a generation prompt by transforming the prompt sentence and at least part of the interaction history into a specific data structure suitable for input to the generative AI model. In one embodiment, the generation prompt includes multiple segments, such as a system instruction segment, a user requirement segment, and a context segment. The server constructs these segments by concatenating text, inserting delimiters, and applying predetermined templates stored in the storage unit. For example, the server may construct a generation prompt that includes:

“User prompt sentence: I want an idea for a new smartphone app. Generate one creative, feasible app idea in 3-4 sentences.”

The server converts the generation prompt into tokens using a tokenizer associated with the generative AI model, and maps each token to an embedding vector. The server then supplies the sequence of embedding vectors, along with internal state such as positional encodings, to the generative AI model. The generative AI model performs a sequence of numerical operations defined by its neural network architecture. These operations include matrix multiplications, non-linear activations, and attention scoring. The model uses learned attention weights to focus on relevant parts of the generation prompt and the interaction history. The model outputs a sequence of tokens representing idea information, such as:

“An app that monitors the user's health status in real time and provides personalized health advice.”

The server converts the token sequence back to text and stores the idea information in the storage unit, associating it with the corresponding prompt sentence and interaction history record. This association uses specific keys and indices in the storage unit, so that the server can later retrieve all related data efficiently. By maintaining a normalized and indexed data structure for these associations, the server reduces latency in retrieval and supports high-throughput operation for multiple concurrent users.

The server then causes the terminal to present the idea information. The terminal receives the idea information, renders it in the output area on the display, and allows the user to evaluate the idea information. The user can input feedback information describing desired adjustments, additional requirements, or emotional reactions. For example, the user may input the feedback information:

“I want more unique features.”

In another example, the user may input:

“Please add a feature that analyzes voice tone and measures stress.”

The terminal sends the feedback information to the server. The server stores the feedback information as part of the interaction history and associates it with the corresponding idea information and prompt sentence. The server then performs emotion analysis on the feedback information. In one embodiment, the server applies a sentiment analysis model implemented as a separate neural network. This model receives as input an embedding representation of the feedback information and outputs an emotion vector indicating sentiment polarity, intensity, and categories such as frustration, satisfaction, or curiosity. The server stores the emotion vector as emotion information linked to the feedback record.

The server reconstructs the generation prompt using both the original prompt sentence and the feedback information, and optionally the emotion information. In one configuration, the server applies a rule-based system that selects portions of the interaction history and emotion information to include in the generation prompt. For example, if the emotion analysis indicates low satisfaction, the server increases the level of detail in the instructions to the generative AI model or adjusts generation conditions, such as lowering temperature to make responses more focused. The reconstruction process uses explicit rules that define how to insert user feedback, how to annotate the original idea information, and how to specify refinement goals, resulting in a generation prompt such as:

“Original prompt: I want an idea for a new smartphone app.

Generated idea: An app that monitors the user's health status in real time and provides personalized health advice.

User feedback: I want more unique features.

Based on the feedback, revise the idea to include at least two distinctive, innovative features that are uncommon in existing health apps. Output the refined idea in 3-5 sentences.”

The server again tokenizes the reconstructed generation prompt, feeds it into the generative AI model, and receives improved idea information. For example, the improved idea information may be:

“An app that monitors the user's health in real time, provides personalized health advice, and additionally analyzes the user's voice tone during phone calls and voice memos to estimate stress levels and emotional state, then suggests tailored relaxation exercises and micro-breaks.”

The server stores the improved idea information in the storage unit as a new version associated with the prior idea information, the prompt sentence, the feedback information, and the emotion information. The server maintains version identifiers and references between versions, thereby allowing efficient traversal of the refinement history. This structured version management enables the server to avoid storing redundant full copies of context and to reuse shared context portions when constructing further generation prompts, thus improving memory efficiency and reducing computational overhead.

The server uses the emotion information not only to guide reconstruction of the generation prompt, but also to control presentation order and content adjustment when multiple pieces of idea information or improved idea information exist. For example, if emotion analysis indicates strong negative sentiment for earlier variants, the server may prioritize presentation of newer, more positively received variants. The server may also suppress or summarize low-rated variants to reduce clutter on the terminal's display, thereby improving the user's interaction efficiency and reducing unnecessary network transmission of low-value data. The server dynamically controls the input context to the generative AI model based on the interaction history and emotion information. The server decides, according to predetermined rules and thresholds, how much prior context to include in each model invocation. For instance, the server may limit the number of prior turns included, or may compress earlier interaction data into summary sentences, when the total token count approaches a limit. This dynamic context control reduces the number of tokens processed per invocation, which leads to faster inference and reduced computational resource usage, while preserving context elements that are most relevant to the user's current requirements.

In one embodiment, the generative AI model is trained through supervised learning and reinforcement learning techniques. The server, or another training system, uses a corpus of prompt sentences, idea information, and feedback pairs to train the neural network. During training, the server uses an objective function such as cross-entropy loss over predicted tokens and may incorporate additional loss terms that penalize deviations from desired refinement behavior. The server updates model weights by performing gradient descent using an optimizer algorithm. To improve robustness, the server may apply data augmentation techniques, such as paraphrasing prompt sentences or adding synthetic feedback, thereby exposing the model to a wide range of refinement patterns during training. By designing the model's training process to reflect feedback-driven refinement tasks, the server achieves higher accuracy and stability when operating on real user feedback and interaction histories. The server differs from a system that merely automates human drafting or idea refinement. The server applies non-conventional data structuring and control logic that are specifically tailored to the properties of a transformer-based generative AI model. The server uses interaction history as a stateful data structure with explicit associations and versions, and uses emotion analysis and rule-based prompt reconstruction to drive dynamic context selection and generation condition adjustment. These mechanisms improve the performance of the computing system itself, including reduced inference latency through controlled context size, improved generation quality through targeted prompt restructuring, and improved data management through association and versioning in the storage unit.

The server can be implemented in various deployment configurations. In one alternative embodiment, the generative AI model is executed on a specialized accelerator device physically attached to the server, and the server schedules inference requests to the accelerator to maximize throughput. In another embodiment, the generative AI model is provided by a remote inference service, and the server includes a communication module that adapts the generation prompts and interaction history into a format required by the remote service. In both cases, the server's data structuring, emotion analysis, and dynamic prompt reconstruction functions remain substantially the same, and the technical effects of improved computational efficiency and adaptive control are maintained.

The terminal may also adopt various forms. In one embodiment, the terminal is a handheld communication device with a touch-sensitive display. In another embodiment, the terminal is a desktop information processing apparatus with a keyboard and a pointing device. The terminal may implement client-side caching of interaction history segments to reduce network traffic. For example, when the server transmits multiple versions of idea information, the terminal may store them locally and request from the server only incremental updates. This reduces communication load and improves responsiveness, particularly in low-bandwidth environments.

The user can operate the system in multiple use scenarios. In one scenario, the user iteratively refines a creative work concept. In another scenario, the user explores multiple branches of idea information in parallel, with the server managing branch identifiers and relationships among branches. The server's structured storage and dynamic context control enable these scenarios without a linear increase in computational cost, because the server can selectively include only relevant branch context in each generation prompt and avoid duplicating unrelated history.

Through the interactions described above, the server, terminal, and user together implement a system in which prompt sentences, feedback information, and emotion information are treated as structured technical data. The server's configuration and control algorithms cause the generative AI model to be used in a way that improves the operation of the computing system, providing technical advantages such as faster processing, more efficient memory usage, reduced network load, and higher accuracy in generating idea information that is aligned with the user's current state and requirements.

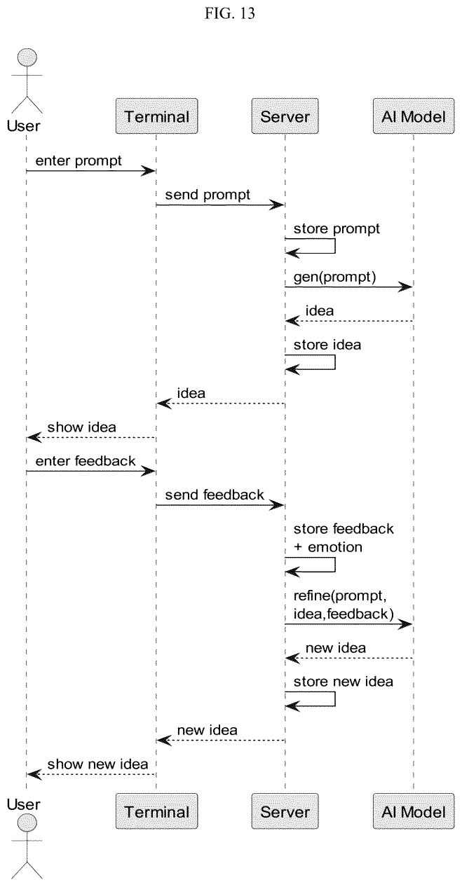

The following describes the processing flow using FIG. 13.

### Step 1

User operates the terminal to input a prompt sentence.

User views an input field on the terminal display and types a prompt sentence such as “I want an idea for a new smartphone app.” as natural language text.

Input: Raw user keystrokes or touch events.

Processing: Terminal converts the keystrokes or touch events into a character string in a predetermined character encoding and assembles the characters into a complete prompt sentence data object.

Output: A prompt sentence stored temporarily in the terminal's memory as a text string.

### Step 2

Terminal structures and transmits the prompt sentence to the server.

Terminal creates a request payload that includes the prompt sentence, a user identifier, and a timestamp, and encapsulates this payload in a network message using a communication protocol.

Input: The prompt sentence text string and local user/session metadata.

Processing: Terminal packages the prompt sentence and metadata into a structured data format, establishes a secure network connection to the server, and performs error checking and encoding (for example, URL and header encoding).

Output: A network message containing the prompt sentence and metadata sent to the server.

### Step 3

Server receives and validates the prompt sentence.

Server accepts the incoming network message, decodes the structured data, and extracts the prompt sentence and associated metadata.

Input: The network message from the terminal containing the prompt sentence and metadata.

Processing: Server parses the payload, checks that the prompt sentence is not empty and within length limits, and verifies that required fields (such as user identifier) are present and syntactically correct.

Output: A validated prompt sentence object and associated metadata in the server's working memory.

### Step 4

Server stores the prompt sentence into an interaction history structure.

Server creates or updates records in a storage unit to register a new interaction entry linked to the user.

Input: The validated prompt sentence object and metadata (user identifier, timestamp).

Processing: Server generates a unique prompt identifier, constructs a database record (or equivalent data structure) containing the prompt sentence, the user identifier, and the timestamp, and writes this record into persistent storage with appropriate indexing.

Output: A stored interaction history entry that associates the user with the prompt sentence via the prompt identifier.

### Step 5

Server constructs a generation prompt based on the prompt sentence and context.

Server generates a formatted text instruction for the generative AI model, combining the prompt sentence with predetermined template text and possibly previous context.

Input: The prompt sentence object and any relevant prior interaction history for the user.

Processing: Server selects applicable templates, concatenates template segments and the prompt sentence, inserts delimiters or markers, and generates a single generation prompt string optimized for the generative AI model.

Output: A generation prompt text string ready for tokenization.

### Step 6

Server converts the generation prompt into tokenized model input.

Server uses a tokenizer associated with the generative AI model to map the generation prompt text to a sequence of discrete tokens.

Input: The generation prompt text string.

Processing: Server applies a tokenization algorithm that segments the text into subword units, assigns token identifiers to each segment, and generates an ordered sequence of token identifiers representing the entire prompt.

Output: A token sequence and associated positional information representing the generation prompt in numerical form.

### Step 7

Server performs numerical embedding and forwards data to the generative AI model.

Server maps token identifiers to numeric embedding vectors and submits these vectors to the generative AI model for processing.

Input: The token sequence produced in Step 6.

Processing: Server looks up each token identifier in an embedding matrix to obtain a high-dimensional vector, combines these with positional encodings, and arranges the resulting vectors into a tensor that matches the input format of the generative AI model.

Output: An embedding tensor provided as input to the generative AI model.

### Step 8

Server executes the generative AI model to generate idea information.

Server invokes the generative AI model, which performs internal computations to produce output tokens representing idea information.

Input: The embedding tensor and model control parameters (e.g., temperature, maximum token count, sampling strategy).

Processing: Generative AI model applies a series of neural network layers, including multi-head self-attention and feed-forward layers, to compute probability distributions over possible next tokens, then iteratively samples or selects tokens until a termination condition is met.

Output: A sequence of output token identifiers representing generated idea information.

### Step 9

Server converts model output tokens into text-based idea information.

Server transforms the output token sequence into human-readable text for presentation to the user.

Input: The sequence of output token identifiers from the generative AI model.

Processing: Server uses the model's vocabulary mapping to convert each token identifier to a text fragment, concatenates the fragments into a complete string, and normalizes spacing and punctuation.

Output: Idea information expressed as a text string.

### Step 10

Server stores the generated idea information and associates it with the prompt sentence.

Server updates the interaction history in the storage unit to link the new idea information with the originating prompt sentence.

Input: The idea information text string and the prompt identifier.

Processing: Server creates a new record containing the idea information, a reference to the prompt identifier, a generation timestamp, and model parameters, and writes this record to the storage unit with indexes for efficient retrieval.

Output: A stored idea record that is logically associated with the corresponding prompt sentence in the interaction history.

### Step 11

Server transmits the idea information to the terminal.

Server prepares a response message containing the newly generated idea information and necessary identifiers.

Input: The idea information text string and associated identifiers (such as idea identifier and prompt identifier).

Processing: Server packages these data elements into a network response payload, encodes the payload according to the communication protocol, and sends it to the terminal over the network.

Output: A network response message containing the idea information and identifiers delivered to the terminal.

### Step 12

Terminal receives and displays the idea information to the user.

Terminal decodes the server's response and presents the content on the display.

Input: The network response message from the server containing the idea information and identifiers.

Processing: Terminal parses the payload, extracts the idea text and identifiers, formats the text for display (for example, in a scrollable area or dedicated panel), and updates the graphical user interface accordingly.

Output: A rendered display of the idea information visible to the user.

### Step 13

User evaluates the idea information and inputs feedback information.

User reviews the displayed idea information and decides how it should be modified or improved, then enters feedback.

Input: The displayed idea information on the terminal screen.

Processing: User analyzes the content, determines adjustment requests (for example, “I want more unique features”), and uses the input device to type feedback information as natural language text.

Output: A feedback text string entered into the terminal's input field.

### Step 14

Terminal structures and transmits feedback information to the server.

Terminal builds a request that includes the feedback information and links it to the particular idea information.

Input: The feedback text string and local references to the idea identifier and prompt identifier.

Processing: Terminal creates a structured payload that includes fields for feedback text, idea identifier, prompt identifier, and a timestamp, applies encoding for network transmission, and sends the payload to the server using the communication protocol.

Output: A network request message conveying feedback information and associated identifiers to the server.

### Step 15

Server stores feedback information and performs emotion analysis.

Server receives the feedback, saves it in the interaction history, and computes emotion information.

Input: The feedback text string, idea identifier, and prompt identifier from the terminal.

Processing: Server creates a feedback record that includes the feedback text and associations to the relevant idea and prompt records, writes this record to the storage unit, and applies an emotion analysis algorithm that converts the feedback text into numerical features and estimates sentiment or emotional categories.

Output: A stored feedback record and corresponding emotion information linked to the interaction history.

### Step 16

Server reconstructs a generation prompt using the prompt sentence, idea information, and feedback information.

Server merges existing context with new feedback to produce a refined instruction for the generative AI model.

Input: The original prompt sentence, the previously generated idea information, the feedback text, and the emotion information obtained in Step 15.

Processing: Server applies rule-based logic and templates to combine these inputs, determines which segments of the interaction history to include, adjusts instructions based on emotion scores (for example, explicitly stating “add more unique features”), and builds a new generation prompt string that specifies refinement tasks.

Output: A reconstructed generation prompt text string incorporating both original requirements and feedback-based refinements.

### Step 17

Server tokenizes and embeds the reconstructed generation prompt for refinement.

Server prepares the refined prompt for input to the generative AI model in numerical form.

Input: The reconstructed generation prompt text string.

Processing: Server applies the tokenizer to segment the text into tokens, maps these tokens to embedding vectors, and constructs an embedding tensor similar to Step 7, possibly adjusting generation conditions based on emotion information.

Output: An embedding tensor representing the reconstructed generation prompt.

### Step 18

Server executes the generative AI model to generate improved idea information.

Server feeds the refined embedding tensor into the generative AI model to obtain a new output sequence.

Input: The embedding tensor of the reconstructed generation prompt and updated model parameters (for example, altered temperature or maximum token count).

Processing: Generative AI model processes the input through its layers, uses attention to focus on feedback-relevant parts of the context, and produces a new token sequence representing improved idea information that addresses the user's feedback.

Output: A sequence of output token identifiers representing improved idea information.

### Step 19

Server converts and stores the improved idea information with version management.

Server transforms the output token sequence into text and updates the interaction history with a new idea version.

Input: The sequence of output token identifiers and the prior idea identifier and feedback identifier.

Processing: Server maps tokens to text fragments, concatenates them into a complete string, creates a new idea version record that references the previous idea and associated feedback, assigns a version identifier, and stores the record in the storage unit with version linkage.

Output: An improved idea information text string stored as a new version associated with previous records.

### Step 20

Server controls presentation and context for further iterations based on emotion information.

Server decides how to present and whether to further refine idea information by using emotion analysis and stored interaction history.

Input: The improved idea information, the emotion information, and the interaction history.

Processing: Server determines presentation order of idea versions, filters or summarizes less relevant versions, updates context selection rules for future generation prompts, and prepares output data that reflects these decisions, thereby optimizing how content is communicated to the terminal.

Output: A presentation plan and associated data to be sent to the terminal, enabling display of refined idea information and supporting additional iterative refinement cycles if requested by the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented content generation and recommendation systems that utilize a generative AI model typically accept a simple textual request from a user, send a single prompt sentence to the model, and then directly display the generated result. Such systems suffer from several technical limitations in the way information is processed and controlled within the computing environment.

First, known systems generally treat user feedback as unstructured text or as a coarse rating, and do not convert the feedback into structured constraint information that can systematically control subsequent invocations of the generative AI model. As a result, the processor cannot effectively steer the model toward satisfying concrete attributes to be enhanced, reduced, or added, and repeated model calls tend to produce outputs that only loosely reflect the user's evolving requirements. This leads to inefficient use of computational resources, because multiple model invocations may be required before a satisfactory result is obtained, while the internal control logic of the computer remains essentially unchanged.

Second, conventional systems commonly ignore or underutilize user emotion signals, such as facial expressions, voice tone, or affect contained in textual comments. In many implementations, any available emotion analysis is applied merely for user experience purposes (for example, cosmetic adaptation of user interfaces), without integrating the emotion information into the core control loop that governs prompt construction, quality evaluation, and iterative regeneration. Consequently, the computer does not exploit emotion information as a weighting factor or feedback signal for ranking, selecting, or improving candidate outputs, and fails to adapt the generative behavior of the model in a technically meaningful way.

Third, known systems often perform quality evaluation of generated content in an ad hoc or manual manner, without a dedicated module that computes evaluation indices such as requirement conformity, relevance, consistency, novelty, or creativity based on machine-processable signals. Without such evaluation indices, the processor has limited capability to automatically distinguish between higher-quality and lower-quality candidates, or to drive an automated improvement loop that refines inferior candidates by constructing improved prompt sentences. This limits the system's ability to autonomously converge toward outputs that better satisfy user requirements, and makes it difficult to scale to large numbers of users and interactions.

Fourth, existing recommendation mechanisms are commonly decoupled from the generative AI workflow. User histories, feedback, and emotions are sometimes used in separate recommender engines, but they are not systematically fused into preference profiles that directly condition prompt sentences supplied to a generative AI model. As a result, recommendation processes often rely on static or precomputed models, and cannot dynamically leverage the same generative engine that produces content structures and conceptual ideas. The lack of unified control over generation, evaluation, emotion-aware improvement, and recommendation diminishes the overall adaptability and responsiveness of the computing system.

Accordingly, there is a need for an improved computer-implemented system that: (i) structures user feedback into explicit constraint information, (ii) acquires and uses user emotion information as a first-class signal in the control loop, (iii) evaluates generated candidates using machine-computable quality indices, and (iv) orchestrates an iterative regeneration process and recommendation generation process, all under the coordinated control of a processor. Such a system should improve the internal operation of the computer by enabling more efficient and adaptive use of generative AI models, reducing unnecessary model calls, and producing outputs that better satisfy user requirements and preferences in a technically systematic manner.

The specific processing by the specific processing unit 290 of the data processing device 12 in Application Example 2 is realized by the following means.

The present invention provides a server comprising a processor, a memory, a user information input/output unit, a communication interface, and at least one sensor interface, wherein the processor is configured to execute instructions that cause the server to (i) receive, via the user information input/output unit, user input including an information type and an information condition, and analyze the user input to extract abstract attributes related to at least one of a content structure or a conceptual element; (ii) generate, based on the extracted abstract attributes, a prompt sentence that instructs a generative AI model to generate at least one candidate including a content structure proposal, an entity proposal, or an information provision proposal, and transmit query data containing the prompt sentence to the generative AI model via the communication interface; (iii) receive, from the generative AI model, response data containing the at least one candidate in a natural language form, and output the at least one candidate to the user via the user information input/output unit; (iv) acquire, from the user, feedback information including evaluation information or request information associated with the output candidate, and store the feedback information in the memory; (v) perform natural language analysis on the feedback information to generate constraint information encoded as a structured representation indicating at least one attribute to be enhanced, at least one attribute to be reduced, or at least one attribute to be added; (vi) acquire user state information including at least one of facial information, voice information, or text information via the at least one sensor interface, input the user state information to an emotion determination model, estimate an emotional state of the user, and store emotion information including at least one emotion type and at least one emotion intensity in the memory; (vii) compute, based on the constraint information, the emotion information, and the at least one candidate, one or more evaluation indices including at least one of requirement conformity, relevance, consistency, novelty, or creativity, and output a quality evaluation result representing a quality of the at least one candidate; (viii) construct an improvement prompt sentence that includes a description of the at least one candidate and an improvement condition derived from the constraint information, the emotion information, and the quality evaluation result, and transmit the improvement prompt sentence to the generative AI model as new query data so as to cause the generative AI model to iteratively regenerate and improve the at least one candidate; and (ix) generate, based on at least one of user history stored in the memory, the feedback information, and the emotion information, a preference profile representing preferences of the user, construct a recommendation prompt sentence that incorporates the preference profile as conditioning information for the generative AI model, transmit the recommendation prompt sentence to the generative AI model, receive recommendation information including at least one unexperienced content or new proposal from the generative AI model, and output the recommendation information to the user via the user information input/output unit. This enables the computer system to internally transform unstructured user feedback and emotion signals into structured constraint information and evaluative indices, to automatically control the construction of prompt sentences and improvement prompt sentences supplied to the generative AI model, to iteratively regenerate and rank candidate outputs based on quality and emotion-aware weighting, and to integrate user preference profiles into generative recommendation processes, thereby improving the technical operation of the server in terms of efficiency, adaptability, and quality of AI-generated content and recommendations.

The term “processor” refers to a hardware computation unit or a combination of hardware computation units configured to execute machine-readable instructions and to control data processing operations within the system.

The term “memory” refers to a hardware storage device or a combination of hardware storage devices configured to store instructions, input data, intermediate data, and output data used by the processor.

The term “user information input/output unit” refers to a hardware and software interface configured to enable bidirectional communication between the system and a user, including at least one of a display device, a pointing device, a keyboard, a touch panel, a microphone, a speaker, or a network-based user interface.

The term “communication interface” refers to a hardware and software communication component configured to send data to and receive data from an external device or service via a communication network.

The term “sensor interface” refers to a hardware and software component configured to acquire sensor data from at least one sensor, including at least one of an image acquisition device, an audio acquisition device, or another user state acquisition device.

The term “user input” refers to information supplied by a user via the user information input/output unit, including at least one of an information type, an information condition, a textual instruction, or a selection made through a graphical user interface.

The term “information type” refers to a classification of requested information, including at least one of a content category, a genre, a topic, or a domain.

The term “information condition” refers to a constraint or requirement associated with the requested information, including at least one of a setting, a theme, a target audience, a style, a tone, or a contextual restriction.

The term “abstract attribute” refers to a generalized feature extracted from user input, representing at least one of a structural property, a semantic property, or a preference-related property used to characterize content or a conceptual element.

The term “prompt sentence” refers to a machine-generated or machine-constructed natural-language instruction string supplied to a generative AI model, the instruction string specifying conditions or guidelines for generating at least one candidate.

The term “generative AI model” refers to a machine learning model configured to generate natural-language text or other content based on an input prompt, using probabilistic or neural network-based generative techniques.

The term “candidate” refers to a content item generated by the generative AI model, including at least one of a content structure proposal, an entity proposal, or an information provision proposal.

The term “content structure proposal” refers to a generated representation specifying an organization or flow of content, including at least one of a plot outline, a section structure, a scenario sequence, or a conceptual framework.

The term “entity proposal” refers to a generated representation of an individual element to appear in content, including at least one of a character, an actor, an object, a place, or a conceptual entity together with associated attributes.

The term “information provision proposal” refers to a generated representation describing how specific information should be presented or recommended to a user, including at least one of a summary, a list of items, or a structured explanation.

The term “query data” refers to data transmitted from the system to the generative AI model, including at least the prompt sentence and optionally additional conditioning information or parameters.

The term “response data” refers to data received from the generative AI model, including generated text corresponding to at least one candidate and optionally metadata or scoring information.

The term “feedback information” refers to data acquired from the user regarding at least one candidate, including at least one of evaluation information, request information, or additional constraints expressed in natural language or structured form.

The term “evaluation information” refers to information indicating a user's assessment of a candidate, including at least one of a rating, a preference indication, an approval, a disapproval, or a qualitative comment.

The term “request information” refers to information indicating desired modifications to a candidate, including at least one of a request to emphasize a feature, to reduce a feature, or to add a new feature.

The term “stored information” refers to data kept in the memory over time, including at least one of user inputs, candidates, feedback information, emotion information, evaluation results, and preference profiles.

The term “constraint information” refers to structured data derived from feedback information, specifying at least one attribute to be enhanced, at least one attribute to be reduced, or at least one attribute to be added in relation to a candidate.

The term “structured representation” refers to a data format in which information is represented using explicit fields, labels, and relationships, enabling programmatic interpretation and processing by the processor.

The term “user state information” refers to data indicating a current condition of the user, including at least one of facial information, voice information, or text information associated with the user's reactions or interactions.

The term “facial information” refers to image data or image feature data representing at least a portion of the user's face, suitable for analysis of facial expressions or other visual indicators of emotion.

The term “voice information” refers to audio data or audio feature data representing speech or other sounds produced by the user, suitable for analysis of prosody, tone, or other acoustic indicators of emotion.

The term “text information” refers to natural-language text produced or selected by the user, including at least one of feedback text, comments, or messages.

The term “emotion determination model” refers to a computational model configured to receive user state information and output emotion information, the computational model including at least one of a statistical model, a neural network model, or a rule-based model.

The term “emotion information” refers to data indicating an estimated emotional state of the user, including at least one emotion type and optionally at least one emotion intensity.

The term “emotion type” refers to a category of emotional state, including at least one of joy, surprise, sadness, anger, fear, satisfaction, dissatisfaction, or neutrality.

The term “emotion intensity” refers to a quantitative or qualitative measure indicating a strength or degree of an emotion type.

The term “evaluation index” refers to a numeric or symbolic value computed by the system to represent an aspect of candidate quality, including at least one of requirement conformity, relevance, consistency, novelty, or creativity.

The term “requirement conformity” refers to an evaluation index indicating a degree to which a candidate satisfies specified user requirements or constraint information.

The term “relevance” refers to an evaluation index indicating a degree to which a candidate is semantically related to user input, context, or intended topic.

The term “consistency” refers to an evaluation index indicating a degree to which a candidate is logically coherent, internally self-consistent, and free from contradictions.

The term “novelty” refers to an evaluation index indicating a degree to which a candidate differs from reference content or prior candidates, as measured by similarity metrics or diversity metrics.

The term “creativity” refers to an evaluation index indicating a degree to which a candidate exhibits originality, unexpectedness, or inventive combination of elements.

The term “quality evaluation result” refers to a set of evaluation indices or aggregated scores representing an overall assessment of the quality of at least one candidate.

The term “improvement condition” refers to a set of conditions used to direct revised generation of a candidate, the set including at least constraint information, emotion information, and a quality evaluation result.

The term “improvement prompt sentence” refers to a prompt sentence constructed to instruct the generative AI model to revise an existing candidate based on an improvement condition, including a description of the existing candidate and specified modifications.

The term “iteratively regenerate” refers to repeatedly invoking the generative AI model with updated prompt sentences in order to refine or improve a candidate over multiple generation cycles.

The term “use history” refers to recorded data indicating past interactions of the user with the system, including at least one of accessed items, generated candidates, accepted proposals, and associated timestamps.

The term “preference profile” refers to structured data representing a model of a user's preferences, derived from at least one of use history, feedback information, and emotion information.

The term “recommendation prompt sentence” refers to a prompt sentence constructed to instruct the generative AI model to generate recommendation information, the prompt sentence including at least the preference profile as conditioning information.

The term “recommendation information” refers to generated information indicating at least one recommended item, including at least one unexperienced content or a new proposal, optionally with explanatory text.

The term “unexperienced content” refers to a content item or category that has not been previously accessed or accepted by the user according to the use history.

The term “new proposal” refers to a candidate idea or concept not previously presented to the user within the recorded use history.

The term “presentation candidate” refers to at least one candidate selected from a plurality of candidates for output to the user based on evaluation indices and emotion information.

The term “non-selected candidate” refers to at least one candidate among a plurality of candidates that is not chosen as a presentation candidate at a given selection stage.

The term “weight factor” refers to a numeric or symbolic value derived from emotion information and used to adjust or correct evaluation indices or quality scores of candidates.

The term “regeneration process” refers to a process in which the system supplies an improvement prompt sentence or an updated prompt sentence to the generative AI model in order to obtain a revised version of at least one candidate.

In one embodiment, a server cooperates with at least one terminal operated by a user to implement the claimed system. The server includes a processor, a memory, a communication interface, a user information input/output unit implemented as a network-based user interface, and at least one sensor interface connected to an image acquisition device and/or an audio acquisition device. The terminal includes at least a display device, an input device such as a touchscreen or keyboard, a camera, and a microphone. The user operates the terminal to interact with the server through a web browser or a dedicated application.

The server uses a software stack that may include an operating system, a web application framework such as a generic server-side framework, a database management system such as a relational database, and a natural language processing library such as a general-purpose NLP toolkit. The server executes a generative AI model, or accesses a generative AI model via the communication interface, where the generative AI model is implemented as a neural network architecture such as a transformer-based sequence model trained for natural language generation. The generative AI model is trained using a supervised or self-supervised learning procedure on large-scale text corpora, with a loss function such as a cross-entropy loss that measures prediction error over tokens, and with parameters (weights) updated by an optimization algorithm such as stochastic gradient descent or a variant thereof.

The server stores user input data, feedback data, emotion data, and generated candidates in the memory using structured data formats. For example, the server represents a candidate as a record including fields for a content structure proposal, an entity proposal, and an information provision proposal. The server represents constraint information as a structured list or map of attributes to be enhanced, reduced, or added, where each attribute is represented as an abstract label and associated weight. The server also stores evaluation indices for each candidate, including requirement conformity, relevance, consistency, novelty, and creativity, as numeric scores.

The server analyzes user input using a natural language processing module implemented on the processor. The server uses tokenization, part-of-speech tagging, dependency parsing, and named-entity recognition algorithms provided by the NLP library to convert free-form user input into abstract attributes. The server then constructs a prompt sentence for the generative AI model by inserting these abstract attributes into a predefined prompt template. For example, when the user specifies that the information type is a fantasy novel and the condition is a medieval European setting with a magician as protagonist, the server constructs a prompt sentence such as:

“Generate a detailed plot outline and main character descriptions for a fantasy novel. The setting is a medieval European-style world, and the protagonist is a magician.”

In another example, when the user requests marketing concepts targeting young people with environmental constraints, the server constructs a prompt sentence such as:

“Generate three new marketing strategy ideas targeting young people that emphasize environmentally friendly products and sustainable practices.”

The server transmits the constructed prompt sentence to the generative AI model as input. The generative AI model uses internal attention mechanisms to compute contextual representations of each token in the prompt sentence and to generate subsequent tokens that form the candidate output. Internally, the generative AI model uses a multi-layer transformer architecture, wherein each layer includes a multi-head self-attention sub-layer and a feedforward sub-layer. The model computes attention weights based on learned query, key, and value projections of token embeddings. The model uses layer normalization and residual connections to stabilize training and inference. The server receives the generated tokens from the generative AI model and reconstructs them into natural-language candidates stored in the memory.

The server presents these candidates to the user via the user information input/output unit on the terminal. The user reviews the candidates and enters feedback using textual comments or selection operations. For example, the user may input feedback such as:

“Please increase the adventure elements and reduce the romantic elements, and include more eco-friendly themes.”

The server receives this feedback and performs natural language analysis on the feedback text. The server uses the NLP module to identify phrases indicating desired modifications, such as “increase the adventure elements,” “reduce the romantic elements,” and “include more eco-friendly themes.” The server maps these phrases to abstract attributes such as “adventure,” “romance,” and “eco-friendly,” and classifies them as attributes to be enhanced, reduced, or added. By storing this constraint information as structured data, the server can later use it systematically to control the generative AI model's behavior.

The server further acquires emotion information from the user. The terminal captures the user's facial expressions through the camera and the user's voice through the microphone.

The server receives the captured image and audio signals via the communication interface and passes them to an emotion determination model. The emotion determination model may be implemented as a convolutional neural network for image-based emotion recognition and as a recurrent or transformer-based network for audio-based emotion recognition. The model extracts facial features such as eye shape, mouth curvature, and facial muscle activation, and audio features such as pitch, amplitude, and spectral characteristics, and classifies them into emotion types such as joy, surprise, dissatisfaction, or neutrality. The model outputs emotion types and emotion intensities as emotion information, which the server stores in the memory.

The server also analyzes textual feedback using a separate emotion analysis module to detect affective tone in the text. The server uses the emotion information as a weight factor when evaluating candidates. For example, when the user shows strong surprise or joy in response to certain elements in a plot, the server increases the evaluation index for creativity or novelty for that candidate and for those elements specifically.

The server includes a quality evaluation module configured to compute evaluation indices using both the constraint information and the emotion information. The server calculates a requirement conformity index by measuring the degree to which a candidate includes attributes indicated in the constraint information. This calculation may be performed using keyword matching, semantic similarity metrics based on sentence embeddings, or topic modeling. The server calculates a relevance index by computing similarity between the candidate and the original user input and use history. The server calculates a consistency index by detecting logical contradictions or incoherent transitions in the candidate using rule-based checks and language model probabilities. The server calculates novelty by comparing sentence embeddings of the candidate to stored embeddings of historical content; low similarity corresponds to high novelty. The server calculates creativity by combining novelty with structural diversity indicators, such as variation in plot arcs or combinations of entity types.

The server then constructs an improvement prompt sentence that explicitly encodes the candidate, the constraint information, the evaluation indices, and the emotion information. For example, the server constructs an improvement prompt sentence such as:

“Here is the current fantasy novel plot: [plot text].

User feedback: increase adventure, reduce romance, and add eco-friendly elements.

Evaluation: requirement conformity is moderate, relevance is high, creativity is moderate.

User emotion: mild dissatisfaction.

Revise the plot to significantly increase adventurous scenes and dangerous encounters, minimize romantic subplots, and incorporate strong eco-friendly themes such as sustainable magic and environmental protection, while maintaining the medieval European setting and magician protagonist.”

The server submits this improvement prompt sentence to the generative AI model. By including structured constraint information and evaluation indices explicitly in the improvement prompt sentence, the server enables the generative AI model to adjust its internal attention and token generation patterns in a targeted manner. This leads to more efficient convergence to acceptable candidates within fewer regeneration cycles, thereby reducing communication traffic and server-side computation for repeated generations.

The server further uses the collected use history, feedback, and emotion information to construct a preference profile for each user. The server aggregates past user interactions, including accepted candidates, rejected candidates, and associated emotion responses, into a feature vector representing user preferences over genres, themes, structures, and emotional tones. The server may train a smaller auxiliary model, such as a feedforward neural network or a logistic regression model, operating on these feature vectors to predict user satisfaction. The server uses this preference profile to condition recommendation prompt sentences. For example, the server constructs a recommendation prompt sentence such as:

“User history: the user has watched multiple action movies and occasionally romance dramas.

User feedback: the user likes action movies and finds slow romantic scenes boring.

User emotion: strong joy detected during action scenes, boredom during slow, dialogue-heavy sequences.

Generate recommendations for five action movies that the user has not watched yet. For each recommended movie, provide a one-sentence explanation of why it matches the user's preferences.”

The server transmits this recommendation prompt sentence to the generative AI model, which generates descriptions of recommended items. The server then filters out items that appear in the use history and outputs only unseen items to the user. This integration of generative AI-based content generation with a structured preference profile improves the precision and relevance of recommendations.

The server improves computer technology by restructuring unstructured feedback and emotion signals into machine-interpretable constraint information and evaluation indices, and by embedding these into prompt sentences and improvement prompt sentences to tightly control the generative AI model. This control mechanism is not a mere automation of human editorial work, because a human editor does not typically maintain and apply multi-dimensional constraint vectors and emotion-weighted evaluation indices across tens or hundreds of iterative generations in real time. The server instead performs systematic numerical operations on large data sets, including similarity computations, embedding operations, and emotion-weighted scoring, which are infeasible to execute in a consistent and scalable way by manual processes.

The server further enhances technical performance by reducing the number of unnecessary generative AI model calls. By evaluating candidate quality and using improvement conditions, the server can terminate regeneration when evaluation indices exceed predetermined thresholds. This reduces processing load on the generative AI model, decreases network traffic between the server and any external AI service endpoints, and lowers response time for the user. Additionally, because the server stores structured constraint information and emotion information, the server can reuse these data across sessions to initialize future prompt sentences more accurately, reducing cold-start latency and improving the starting quality of subsequent candidates.

In another embodiment, the server executes the generative AI model locally on specialized hardware such as a graphics processing unit. The server loads a transformer-based neural network model with multiple encoder-decoder layers, each having a fixed number of attention heads and hidden units. During training, the server adjusts model weights based on a loss function that includes not only standard prediction error but also penalty terms encouraging alignment with constraint information and emotion-based labels. For example, the server may augment training data by tagging training examples with synthetic constraint labels and emotion labels, and may use multi-task learning with a joint loss combining language modeling loss and constraint alignment loss. This training method causes the model to internalize correlations between constraint patterns, emotion patterns, and desirable output structures, which further improves the effectiveness of constraint-based prompting in deployment.

In a variant embodiment, the server maintains multiple generative AI models of different sizes or specialized for different domains, such as fiction narratives, technical documents, or marketing texts. The server selects one of these models based on the information type and information condition extracted from user input. The server may also switch models during iterative regeneration if evaluation indices indicate that a different model type is more suitable. This model selection and switching mechanism enhances computation efficiency by using smaller models where appropriate and reserving larger models for more complex tasks. In another variation, the server implements a rule-based post-processing layer that applies technical constraints not directly expressible in natural language, such as maximum length constraints, forbidden phrase lists, or structural templates for the output. The server applies these rules after each generation cycle and before evaluation. If the server detects rule violations, the server adjusts constraint information and constructs an updated improvement prompt sentence describing the violation, thereby instructing the generative AI model to avoid those patterns. This rule-based layer interacts with the neural model in a closed loop, providing technical safeguards and further improving output reliability and safety.

The terminal may also perform pre-processing or post-processing operations to reduce server load. For example, the terminal may downsample video frames before sending them to the server for emotion analysis, or may perform local rendering and layout of long text outputs to optimize user experience. The terminal may cache previously retrieved candidates for offline browsing, while the server maintains synchronized records of which candidates the user has actually viewed and for how long, thus enriching the use history data.

Because the server centralizes complex computation, including natural language parsing, embedding computations, evaluation index calculations, and emotion-aware scoring, and because the server controls the generative AI model via structured prompt sentences and improvement prompt sentences, the system realizes technical effects such as improved processing speed, more accurate content generation aligned with user intent, reduced network traffic, and enhanced data management. The server not only executes generic data retrieval and display routines, but also implements specific algorithmic flows and data structures that directly influence the internal operation of the generative AI model and the control logic of the computing system.

In summary, the server uses a combination of structured constraint extraction, emotion-aware evaluation, iterative improvement via improvement prompt sentences, and preference-profile-conditioned recommendation prompt sentences to control the generative AI model. These operations produce technical improvements in the computing environment by optimizing data flows, reducing redundant computations, and improving the precision and usefulness of AI-generated content and recommendations beyond what is achievable by conventional systems that merely relay user requests to a generative AI model in a single-pass manner.

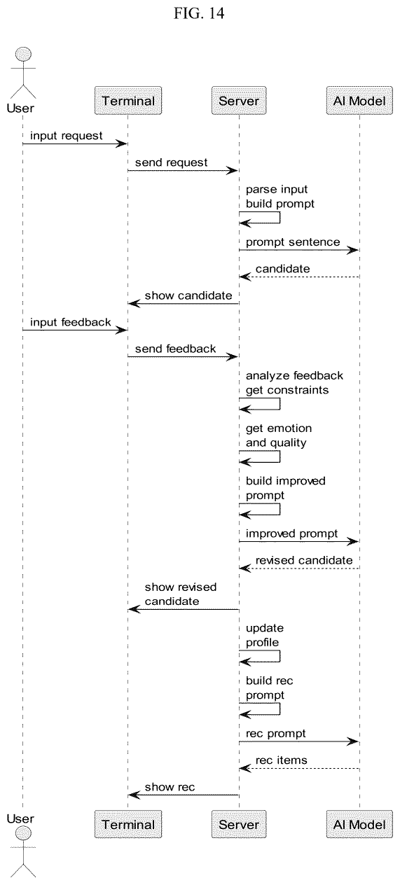

The following describes the processing flow using FIG. 14.

### Step 1

The user operates the terminal to input an information type and information conditions.

The terminal displays an input screen including fields for content category, genre, setting, style, and optional free-text instructions.

Input: raw user keystrokes or touch events.

The terminal converts these events into a structured text string (for example, “fantasy novel, medieval European setting, magician protagonist, high level of adventure”) and sends the text to the server via a network protocol.

Output: a network message containing the user input text and a user identifier.

### Step 2

The server receives the user input and parses it into abstract attributes.

Input: the network message including the user input text and user identifier.

The server uses a natural language processing library to perform tokenization, part-of-speech tagging, and dependency parsing on the user input text. The server extracts abstract attributes such as information type (for example, “narrative content”), genre (for example, “fantasy”), setting (for example, “medieval European-style world”), and key constraints (for example, “magician protagonist,” “high adventure”).

The server converts these extracted elements into a structured representation such as a list or map of attributes.

Output: structured abstract attributes associated with the user identifier.

### Step 3

The server constructs a base prompt sentence for a generative AI model.

Input: the structured abstract attributes from Step 2.

The server inserts the abstract attributes into a predefined prompt template by string concatenation and formatting operations. For example, the server generates the following prompt sentence:

“Generate a detailed plot outline and main character descriptions for a fantasy novel. The setting is a medieval European-style world, and the protagonist is a magician. Emphasize adventurous events and high-stakes conflicts.”

The server attaches generation parameters such as maximum length and creativity level to the prompt sentence.

Output: a base prompt sentence and associated generation parameters.

### Step 4

The server sends the base prompt sentence to the generative AI model and obtains an initial candidate.

Input: the base prompt sentence and generation parameters from Step 3.

The server transmits the prompt sentence to the generative AI model via a model interface.

Internally, the generative AI model embeds each token of the prompt sentence, passes the embeddings through multiple transformer layers, computes attention weights, and predicts subsequent tokens to form an output text sequence.

The server receives the generated token sequence from the model and reconstructs it into a natural-language text representing at least one candidate (for example, a plot outline and character list).

Output: an initial candidate in natural-language form and optional model metadata.

### Step 5

The server stores the initial candidate and related data.

Input: the initial candidate text and metadata from Step 4, together with the user identifier and abstract attributes.

The server creates a record in a database including fields for the candidate text, the prompt sentence used, generation parameters, and a timestamp. The server stores this record linked to the user identifier for later retrieval and evaluation.

Output: a persistent candidate record stored in the server's memory or database.

### Step 6

The server transmits the initial candidate to the terminal, and the terminal displays it to the user.

Input: the candidate record from Step 5.

The server packages the candidate into a response message and sends it to the terminal. The terminal receives the response, parses the candidate text, and renders it on the display using a layout engine. The terminal may separate sections such as “Plot Outline,” “Main Characters,” and “Key Conflicts” for clarity.

Output: a rendered candidate view on the terminal screen that the user can read.

### Step 7

The user reviews the displayed candidate and provides feedback text.

Input: the displayed candidate content on the terminal.

The user reads the candidate, decides what adjustments are desired, and enters feedback such as “Increase the sense of adventure, reduce romance, and add an eco-friendly theme.”

The terminal converts the feedback into a text string associated with the candidate identifier and sends this string to the server.

Output: a feedback message containing the feedback text and candidate identifier.

### Step 8

The server analyzes the feedback and converts it into constraint information.

Input: the feedback text and candidate identifier from Step 7.

The server performs natural language analysis on the feedback text using the NLP library.

The server identifies phrases representing modifications (for example, “increase the sense of adventure,” “reduce romance,” “add an eco-friendly theme”).

The server maps these phrases to standardized attribute labels (for example, “adventure,” “romance,” “eco-friendly”) and classifies each label as an attribute to be enhanced, reduced, or added. The server assigns weights or priorities to each attribute based on word emphasis or frequency.

Output: structured constraint information containing labeled attributes and their modification types and weights.

### Step 9

The terminal captures user state information for emotion estimation and sends it to the server.

Input: user interaction context while the candidate is displayed.

The terminal acquires image frames from the camera and audio samples from the microphone while the user reads the candidate. The terminal optionally downscales the frames or compresses the audio to reduce bandwidth.

The terminal transmits the image and audio data to the server along with timing information that correlates with the displayed candidate.

Output: sensor data packets containing facial image data and voice audio data associated with the candidate.

### Step 10

The server estimates the user's emotional state from the sensor data.

Input: the image and audio data from Step 9 and, optionally, the feedback text.

The server applies an emotion determination model to the image data, for example a convolutional neural network that extracts facial features and classifies them into emotion categories such as joy, surprise, or dissatisfaction. The server applies a recurrent or transformer-based network or other classifier to audio features such as pitch and energy to infer emotional tone. The server may also run a text-based emotion classifier on the feedback text.

The server fuses the outputs from image, audio, and text analysis, for example by weighted averaging or another fusion algorithm, to obtain a consolidated emotion type and intensity.

Output: emotion information containing at least one emotion type and an associated intensity for the candidate.

### Step 11

The server evaluates the quality of the initial candidate using constraint and emotion information.

Input: the candidate text from Step 5, the constraint information from Step 8, and the emotion information from Step 10.

The server computes evaluation indices by performing several data operations. The server calculates requirement conformity by searching the candidate text for attribute-related terms and computing semantic similarity between candidate segments and constraint labels using vector embeddings. The server calculates relevance by comparing the candidate with the original user input attributes. The server calculates consistency by checking for contradictions or abrupt transitions using rule-based patterns and language model scores. The server calculates novelty by comparing embeddings of the candidate against a historical corpus of prior candidates and external references, measuring distance in embedding space. The server calculates creativity as a combination of novelty and structural variety.

The server aggregates these indices into a quality evaluation result and stores it associated with the candidate.

Output: a quality evaluation result containing numerical indices for requirement conformity, relevance, consistency, novelty, and creativity.

### Step 12

The server constructs an improvement prompt sentence based on the candidate, constraint information, and evaluation result.

Input: the candidate text, the structured constraint information, and the quality evaluation result from Step 11, together with the emotion information.

The server formats a new prompt sentence by embedding: (i) a summary or full text of the candidate, (ii) a description of the user feedback, (iii) the evaluation indices, and (iv) the detected emotion type and intensity. For example, the server constructs:

“Here is the current fantasy novel plot: [plot text].

User feedback: increase adventure, reduce romance, and add eco-friendly elements.

Evaluation: requirement conformity is moderate, relevance is high, creativity is moderate.

User emotion: mild dissatisfaction.

Revise the plot to significantly increase adventurous scenes and dangerous encounters, minimize romantic subplots, and incorporate strong eco-friendly themes such as sustainable magic and environmental protection, while maintaining the medieval European setting and magician protagonist.”

The server ensures that this improvement prompt sentence is grammatically coherent and explicitly states the desired modifications.

Output: an improvement prompt sentence and updated generation parameters.

### Step 13

The server sends the improvement prompt sentence to the generative AI model and obtains a revised candidate.

Input: the improvement prompt sentence and updated generation parameters from Step 12.

The server transmits the improvement prompt sentence to the generative AI model.

Internally, the generative AI model processes the longer prompt, which now contains both the original content and the improvement conditions, and adjusts its attention patterns accordingly. The model generates a revised candidate that includes more adventurous events, fewer romantic elements, and explicit eco-friendly themes.

The server receives the revised candidate text and stores it in the database as a new version linked to the original candidate and the improvement conditions.

Output: a revised candidate with improved alignment to the user's requirements and emotional responses.

### Step 14

The server transmits the revised candidate to the terminal, and the terminal presents it to the user.

Input: the revised candidate text from Step 13.

The server encapsulates the revised candidate in a response message and sends it to the terminal. The terminal replaces or augments the original candidate display with the revised candidate, clearly indicating that this is an improved version.

The user reads the revised candidate and may optionally provide further feedback, which can restart the process from Step 7.

Output: a displayed revised candidate on the terminal and the opportunity for additional user feedback.

### Step 15

The server updates the user's preference profile based on recent interactions.

Input: the user's original input, the initial and revised candidates, the feedback information, the emotion information, and the evaluation indices.

The server computes feature values summarizing the user's reactions to specific genres, themes, structures, and emotional tones. The server updates the preference profile by adjusting weights associated with these features, for example increasing the weight for “adventure” and decreasing the weight for “romance” based on the recent feedback and emotion data.

The server stores the updated preference profile in the memory for use in future generations and recommendations.

Output: an updated preference profile associated with the user.

### Step 16

The server generates recommendation prompt sentences and obtains recommendation information.

Input: the updated preference profile from Step 15 and the user's use history.

The server constructs a recommendation prompt sentence that includes a description of the user's preferences and excluded items already experienced. For example, the server generates:

“User history: the user has watched multiple action movies and a few romance dramas.

User feedback: the user likes action movies and finds slow romantic scenes boring.

User emotion: strong joy detected during action scenes and boredom during slow, dialogue-heavy sequences.

Generate recommendations for five action movies that the user has not watched yet. For each recommended movie, provide a one-sentence explanation of why it matches the user's preferences.”

The server sends this recommendation prompt sentence to the generative AI model, receives recommendation descriptions, and filters out items already in the use history.

Output: recommendation information including unseen items and explanatory text.

### Step 17

The server sends the recommendation information to the terminal, and the terminal displays recommended items to the user.

Input: the recommendation information from Step 16.

The server packages the recommendations and transmits them to the terminal. The terminal displays a recommendation list including titles, brief descriptions, and reasons why each item matches the user's preferences. The user can select items for further actions, such as viewing or saving.

Output: a recommendation list presented on the terminal and any subsequent user selections that can be logged for future use history.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

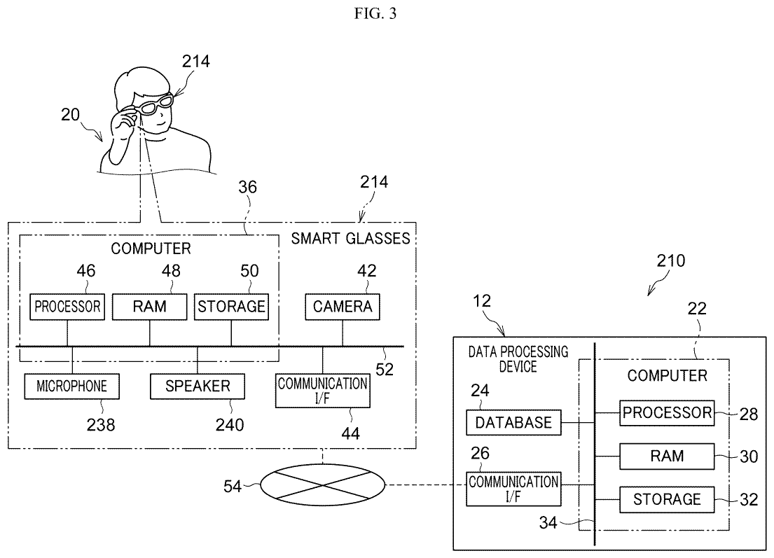

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

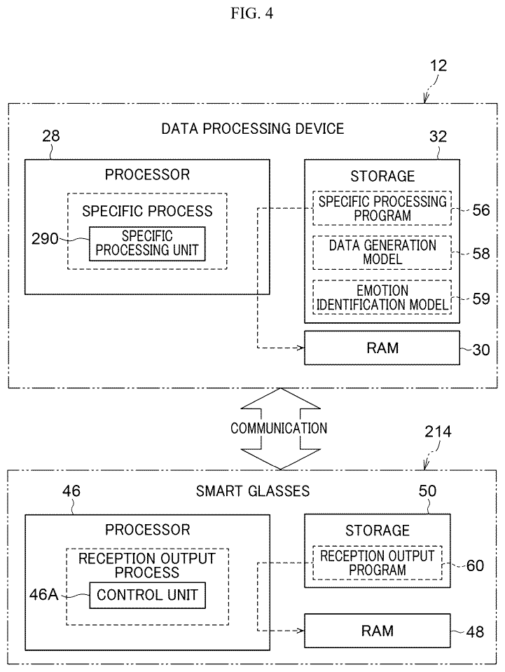

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

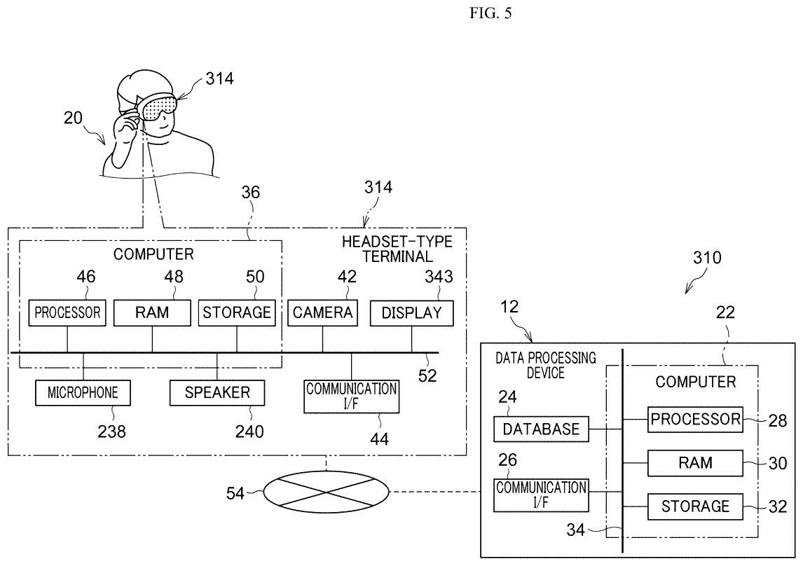

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

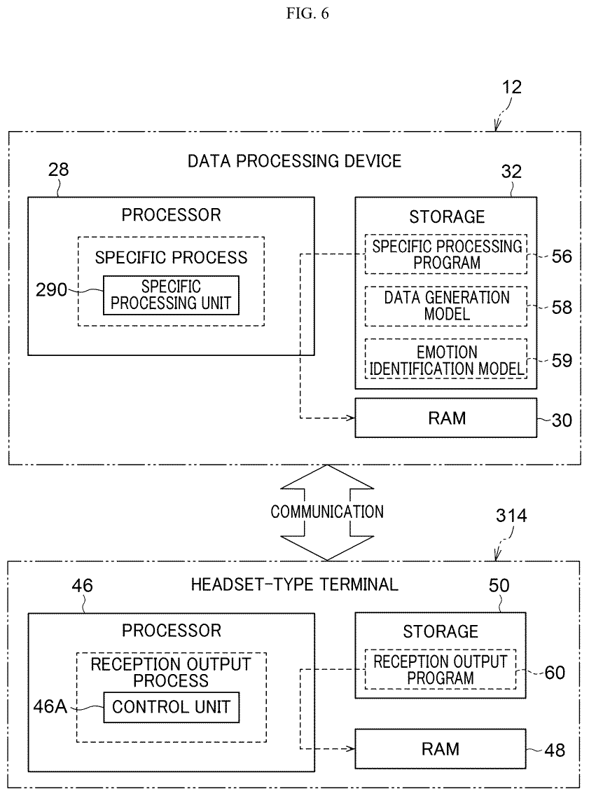

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

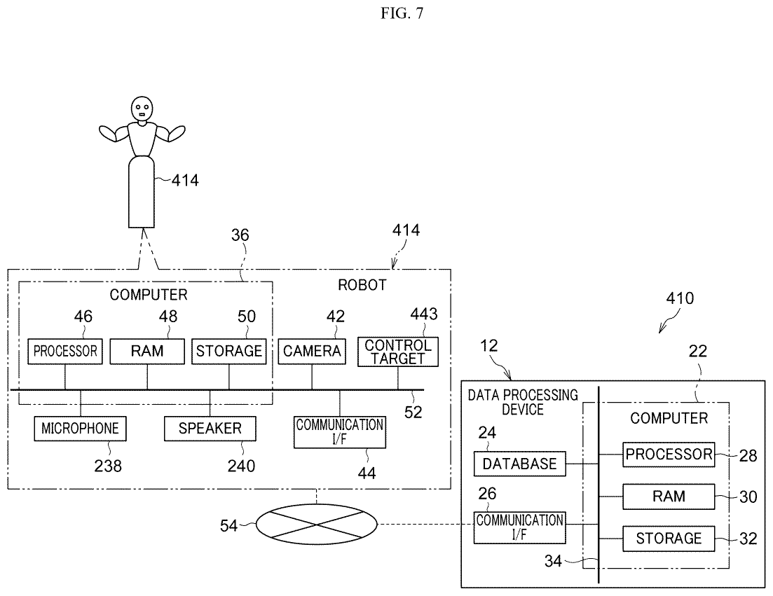

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

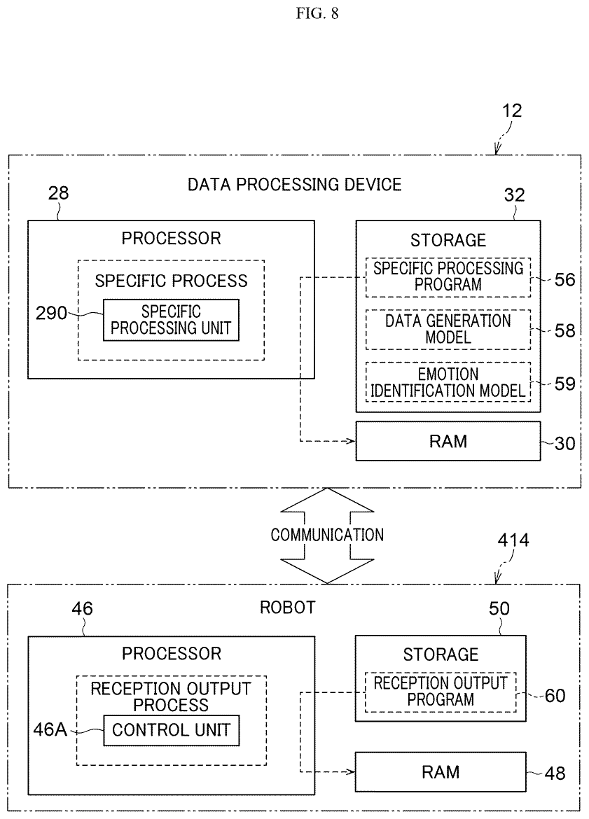

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

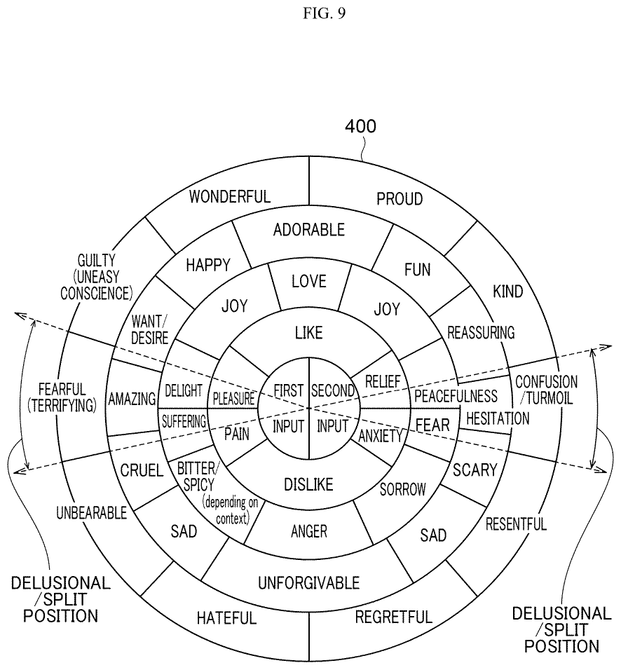

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

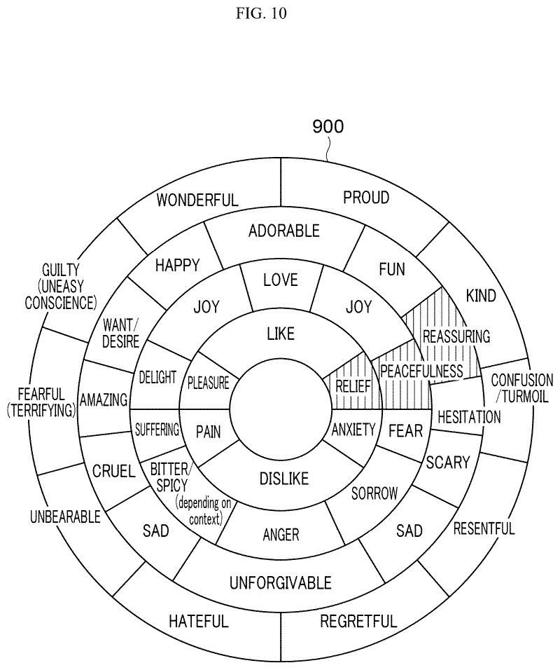

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
provide an information input/output unit that receives, from a user, work attribute information and environment information related to a creative work,
convert the received work attribute information and environment information into structured data, generate a natural language prompt sentence based on the structured data, and supply the prompt sentence to a generative AI model as an input instruction,
obtain story structure information and character information output from the generative AI model, convert the obtained story structure information and character information into presentation data, and present the presentation data to the user via a display unit, and
analyze evaluation information and emotion information acquired from the user with respect to the presented story structure information and character information, and change at least one of contents of the prompt sentence and operation conditions of the generative AI model based on a result of the analysis.

### Supplementary 2

The system according to supplementary 1,
wherein the processor is configured to
accept additional input information including additional work attribute information and additional environment information from the user, regenerate the natural language prompt sentence based on the additional input information, and re-input the regenerated prompt sentence to the generative AI model to regenerate and adjust the story structure information and the character information.

### Supplementary 3

The system according to supplementary 1,
wherein the processor is configured to
analyze the emotion information of the user to generate emotion evaluation information, re-evaluate a quality of the story structure information and the character information output from the generative AI model based on the emotion evaluation information, and automatically change at least one of the natural language prompt sentence and the presentation data according to a result of the re-evaluation.

### Application Example 1

### Supplementary 1

A system comprising a processor,
wherein the processor is configured to
provide, via a display device and an input device, an interface through which a user inputs character information regarding at least a type of a work and a background of the work, and to accept the character information as work-related information from the user,
generate structured data including the character information regarding the type of the work and the background of the work, and generate, based on the structured data, a prompt sentence formatted according to a predetermined format to be input to a generative information processing apparatus,
transmit, via a communication interface, request data including the generated prompt sentence to an external generative information processing apparatus, and cause a generative AI model executed by the external generative information processing apparatus to perform a generation process for generating ideas regarding a structure of a story and settings of appearing entities,
acquire, from the generative AI model, response data including character string data representing generated ideas, analyze the character string data, and divide the character string data into a plurality of regions including information regarding the structure of the story and information regarding the appearing entities, thereby generating structured output data including the plurality of regions,
convert the structured output data into display data in a presentation format for the user, and present, via the display device, the ideas regarding the structure of the story and the settings of the appearing entities to the user,
acquire, via the input device, feedback information representing a reaction of the user to the presented ideas, and perform an emotion analysis process that extracts emotion information of the user using the feedback information, and
calculate an evaluation value of the generated ideas based on the emotion information extracted by the emotion analysis process, and change, in accordance with the evaluation value, at least one of contents of the prompt sentence and control parameters for the generative AI model, and instruct the generative AI model to perform a regeneration process using a modified prompt sentence.

### Supplementary 2

The system according to supplementary 1,
wherein the processor is configured to
acquire, via the input device, additional work-related information or a modification request for the presented ideas from the user, generate an updated prompt sentence by appending the additional work-related information or the modification request to, or replacing a part of, the prompt sentence, retransmit, via the communication interface, request data including the updated prompt sentence to the generative AI model, cause the generative AI model to regenerate the ideas regarding the structure of the story and the settings of the appearing entities based on the updated prompt sentence, and present the regenerated ideas to the user via the display device.

### Supplementary 3

The system according to supplementary 1,
wherein the processor is configured to
store, in a storage device, a time series of the emotion information of the user obtained by the emotion analysis process, update, in a learning manner, evaluation information indicating a correspondence relationship among the type of the work, the background of the work, and at least one of the generated structure of the story and the generated settings of the appearing entities and the emotion information, based on the time series of the emotion information, and automatically adjust, based on the evaluation information, at least one of a format and contents of a subsequently generated prompt sentence so as to adapt a tendency of idea generation by the generative AI model to preferences of the user.

### Example 2

### Supplementary 1

A system comprising a processor,
wherein the processor is configured to
provide an information input/output unit through which a user inputs a prompt sentence including requirement information regarding a creative work,
analyze the prompt sentence acquired via the information input/output unit, generate a generation prompt based on the prompt sentence, and cause a generative artificial intelligence model to generate idea information by inputting the generation prompt to the generative artificial intelligence model,
present the idea information acquired from the generative artificial intelligence model to the user,
acquire feedback information from the user as text data with respect to the idea information,
reconstruct the generation prompt using the acquired feedback information, and cause the generative artificial intelligence model to generate improved idea information in which the idea information is adjusted and improved by re-inputting the reconstructed generation prompt and the idea information to the generative artificial intelligence model,
store the idea information and the improved idea information, and the prompt sentence and the feedback information corresponding to the idea information and the improved idea information, in a storage unit in association with one another, and manage an interaction history with the user based on the association, and
perform emotion analysis on the feedback information acquired from the user, and reflect an analysis result of the emotion analysis in at least one of a presentation order and content adjustment of the idea information and the improved idea information.

### Supplementary 2

The system according to supplementary 1,
wherein the processor is configured to
receive, as the feedback information, an additional prompt sentence including additional requirement information from the user, update the generation prompt based on the additional prompt sentence and the interaction history, and dynamically control input context to the generative artificial intelligence model so as to regenerate, and stepwise adjust and improve, the idea information.

### Supplementary 3

The system according to supplementary 1,
wherein the processor is configured to
re-evaluate a quality of at least one of the idea information and the improved idea information based on emotion information of the user and content of the feedback information, and further improve the idea information by changing at least one of a generation condition for the generative artificial intelligence model and a structure of the generation prompt in accordance with a result of the re-evaluation.

Application Example 2

### Supplementary 1

A system comprising a processor, a memory, and a user information input/output unit,
wherein the processor is configured to
receive, via the user information input/output unit, input information from a user including a type of information and a condition of information, and analyze the input information to extract one or more abstract attributes relating to a structure of content or a conceptual element; and
generate, based on the extracted abstract attributes, a prompt sentence for a generative AI model, the prompt sentence instructing the generative AI model to generate at least one candidate including a content structure proposal, an entity proposal, or an information provision proposal; and
transmit, via a communication interface, query data including the prompt sentence to the generative AI model disposed inside or outside the system, and receive, from the generative AI model, response data including the at least one candidate in a natural language form; and
output, via the user information input/output unit, the at least one candidate included in the response data to the user, acquire feedback information including evaluation information or request information from the user regarding the output candidate as feedback information, and store the feedback information in the memory as stored information; and
perform natural language analysis processing on the feedback information to extract constraint information, the constraint information including at least one of an attribute to be enhanced, an attribute to be reduced, or an attribute to be added, and convert the feedback information into a structured representation of the constraint information; and
acquire, via at least one sensor associated with the user information input/output unit, user state information including at least one of facial information, voice information, or text information, input the user state information to an emotion determination model, estimate an emotional state of the user, and store, in the memory as emotion information, information indicating at least one of an emotion type and an emotion intensity; and
evaluate a quality of the at least one candidate by calculating, based on the constraint information, the emotion information, and the at least one candidate obtained from the generative AI model, one or more evaluation indices including at least one of requirement conformity, relevance, consistency, novelty, or creativity, and output a quality evaluation result; and
generate, based on an improvement condition including at least the constraint information, the emotion information, and the quality evaluation result, an improvement prompt sentence that instructs the generative AI model to perform revised generation of the at least one candidate, the improvement prompt sentence including a description of the at least one candidate and the improvement condition, and transmit the improvement prompt sentence as new query data to the generative AI model so as to iteratively regenerate and improve the content structure proposal, the entity proposal, or the information provision proposal; and
generate, based on at least one of a use history of the user stored in the memory, the feedback information, and the emotion information, a preference profile representing preferences of the user, and construct a recommendation prompt sentence by adding the preference profile to a prompt for the generative AI model, transmit the recommendation prompt sentence to the generative AI model, receive recommendation information including at least one unexperienced content or new proposal from the generative AI model, and output the recommendation information to the user via the user information input/output unit.

### Supplementary 2

The system according to supplementary 1,
wherein the processor is configured to
receive additional input information from the user via the user information input/output unit after outputting the at least one candidate, incorporate the additional input information as a part of at least one of the prompt sentence or the improvement prompt sentence, integrate the additional input information with the constraint information and the emotion information to form an updated improvement condition, and control a regeneration process by the generative AI model based on the updated improvement condition.

### Supplementary 3

The system according to supplementary 1,
wherein the processor is configured to
obtain, from the generative AI model, a plurality of candidates including a plurality of content structure proposals, entity proposals, or information provision proposals, calculate, for each of the plurality of candidates, the one or more evaluation indices as provisional quality scores, correct the provisional quality scores by applying a weight factor derived from the emotion information obtained by the emotion determination model, select, based on corrected evaluation indices, at least one presentation candidate to be output to the user, and execute, for at least one non-selected candidate among the plurality of candidates, a regeneration process using the improvement prompt sentence so as to further improve the non-selected candidate.

What is claimed is:

1. A system comprising:
circuitry configured to:
receive, via a communication interface coupled to a packet-switched network, work attribute information and environment information related to a creative work from a terminal device, and convert the received information into structured data;
generate a natural language prompt sentence based on the structured data, supply the prompt sentence as model input to a generative AI model, and obtain structure information and character information output from the generative AI model;
convert the obtained structure information and character information into presentation data, and transmit the presentation data to the terminal device via the communication interface;
receive evaluation information and emotion information from the terminal device with respect to the presentation data, and analyze the evaluation information and the emotion information to generate an analysis result; and
change at least one of contents of the prompt sentence and operating conditions of the generative AI model based on the analysis result, and supply the changed prompt sentence to the generative AI model to regenerate, adjust, and improve the presentation data.

2. The system according to claim 1, wherein the circuitry is configured to apply a sentiment analysis model to the emotion information received from the terminal device to generate a sentiment score and an emotion label, and use the sentiment score and the emotion label as weighting parameters when generating the analysis result.

3. The system according to claim 2, wherein the circuitry is configured to re-evaluate a quality of the presentation data based on the sentiment score and the emotion label, and generate an improvement directive indicating specific aspects of the structure information and character information to be improved.

4. The system according to claim 3, wherein the circuitry is configured to generate an improvement prompt sentence incorporating the improvement directive, supply the improvement prompt sentence to the generative AI model, and obtain improved presentation data.

5. The system according to claim 4, wherein the circuitry is configured to generate a plurality of candidate presentation data items by supplying the improvement prompt sentence with different generation parameters to the generative AI model, present all candidate items to the terminal device, and execute a regeneration process for at least one non-selected candidate using a further improvement prompt sentence.

6. The system according to claim 1, wherein the circuitry is configured to receive additional input data from the terminal device as a supplementary prompt, incorporate the supplementary prompt into an updated prompt sentence, and supply the updated prompt sentence to the generative AI model to regenerate the presentation data based on the additional input data.

7. The system according to claim 6, wherein the circuitry is configured to apply a consistency verification model to the regenerated presentation data to verify that regenerated structure information and character information are consistent with prior accepted presentation data, and flag inconsistencies for user review via the terminal device.

8. The system according to claim 1, wherein the circuitry is configured to apply a natural language processing model to the work attribute information to extract semantic descriptors for the work type and the contextual setting, and use the extracted semantic descriptors to populate structured data fields in the prompt sentence.

9. The system according to claim 8, wherein the circuitry is configured to apply a style transfer model to the structured data to generate stylistic parameters for inclusion in the prompt sentence, specifying narrative tone, structural complexity, and descriptive density parameters.

10. The system according to claim 1, wherein the circuitry is configured to generate structure information comprising a plurality of structural stages and a causal relationship graph linking the stages, and generate character information comprising personality attributes, motivation parameters, and relationship parameters for each character.

11. The system according to claim 10, wherein the circuitry is configured to apply a logical consistency analysis model to the generated causal relationship graph to verify that causal relationships between structural stages are internally consistent, and regenerate inconsistent stages using an updated prompt sentence.

12. The system according to claim 1, wherein the circuitry is configured to accumulate a version history of prompt sentences and corresponding presentation data in a storage device, and enable retrieval of any prior version via the terminal device to support iterative refinement workflows.

13. The system according to claim 12, wherein the circuitry is configured to apply a comparison model to consecutive versions of the presentation data to identify changes introduced in each iteration, and generate a change summary for transmission to the terminal device.

14. The system according to claim 1, wherein the circuitry is configured to apply a collaborative filtering model to accumulated evaluation information from a plurality of users to identify commonly preferred structural patterns, and incorporate the commonly preferred structural patterns as default parameters in the prompt sentence.

15. The system according to claim 14, wherein the circuitry is configured to generate personalized structural pattern recommendations based on the collaborative filtering model output and the user's evaluation history, and present the recommendations to the terminal device.

16. The system according to claim 1, wherein the circuitry is configured to apply a text coherence model to the structure information and character information to calculate a coherence score, and include the coherence score as a quality metric in the analysis result used to modify the prompt sentence.

17. The system according to claim 16, wherein the circuitry is configured to apply a diversity scoring model to a plurality of candidate presentation data items to identify the most semantically diverse candidate set, and prioritize diverse candidates for presentation to the terminal device.

18. A system comprising:
circuitry configured to:
receive, via a communication interface coupled to a packet-switched network, work attribute information and environment information from a terminal device, convert the received information into structured data, generate a natural language prompt sentence from the structured data, and supply the prompt sentence to a generative AI model to obtain structure information and character information;
convert the structure information and character information into presentation data, transmit the presentation data to the terminal device, receive evaluation information and emotion information in response, and apply a sentiment analysis model to the emotion information to generate a sentiment score and an emotion label;
re-evaluate quality of the presentation data based on the sentiment score and the emotion label, generate an improvement directive, incorporate the improvement directive into an updated prompt sentence, and supply the updated prompt sentence to the generative AI model to regenerate the presentation data;
generate a plurality of candidate presentation data items with different generation parameters, present all candidates to the terminal device, and execute regeneration for non-selected candidates; and
accumulate version history of prompt sentences and corresponding presentation data in a storage device to support iterative refinement.

19. The system according to claim 18, wherein the circuitry is configured to apply a logical consistency analysis model to the causal relationship graph of the structure information, flag inconsistent causal relationships, regenerate flagged stages using an updated prompt sentence, and apply a text coherence model to calculate a coherence score for inclusion in the analysis result.

20. A method comprising:
receiving, via a communication interface coupled to a packet-switched network, work attribute information and environment information related to a creative work from a terminal device, and converting the received information into structured data;
generating a natural language prompt sentence based on the structured data, supplying the prompt sentence as model input to a generative AI model, and obtaining structure information and character information output from the generative AI model;
converting the obtained structure information and character information into presentation data, and transmitting the presentation data to the terminal device via the communication interface;
receiving evaluation information and emotion information from the terminal device with respect to the presentation data, and analyzing the evaluation information and the emotion information to generate an analysis result; and
changing at least one of contents of the prompt sentence and operating conditions of the generative AI model based on the analysis result, and supplying the changed prompt sentence to the generative AI model to regenerate, adjust, and improve the presentation data.
